(19) United States
(12) Patent Application Publication
(10) Pub. No.: US 2025/0243374 A1
(43) Pub. Date: Jul. 31, 2025

(54) INK JET RECORDING METHOD AND INK JET RECORDING APPARATUS

(71) Applicant: CANON KABUSHIKI KAISHA, Tokyo (JP)

(72) Inventors: SAYOKO NAGASHIMA, Kanagawa (JP); NAO ISHIJIMA, Kanagawa (JP)

(21) Appl. No.: 19/035,577

(22) Filed: Jan. 23, 2025

(30) Foreign Application Priority Data
Jan. 25, 2024 (JP) 2024-009740
Dec. 17, 2024 (JP) 2024-221044

(51) Int. Cl. C09D 11/107; B41J 3/28; B41J 11/00; B41M 3/00; B41M 7/00; C09D 11/30

(52) U.S. Cl. CPC C09D 11/107; B41J 3/28; B41J 11/002; B41M 3/001; B41M 7/009; C09D 11/30

(57) ABSTRACT

An ink jet recording method. The reactant comprises organic or inorganic acid. The ink comprises a pigment and a resin particle having the anionic group in an amount of 75 μmol/g or more to 600 μmol/g or less. A content of the resin particle is 1.5 times or more a content of the pigment on a mass basis. Both of a content of a first water-soluble organic solvent having a vapor pressure of 3.1×10⁻⁵ kPa or less and a content of a second water-soluble organic solvent having a relative permittivity of 28.0 or more and a vapor pressure of 4.0×10⁻³ kPa or less are in a content of 9.0 by mass or less based on the total mass of the ink. The heating temperature T_{F} of the medium and a glass transition temperature T_{G} of the resin particle satisfy the formula: T_{F}≥(T_{G}-10).

### BACKGROUND

### Technical Field

The present disclosure relates to an ink jet recording method and an ink jet recording apparatus.

### Description of the Related Art

In recent years, the ink jet recording method has been increasingly used in a field known as sign-and-display to print, for example, posters and large-format advertisements. In this field, in terms of durability and cost of recording media, polyvinyl chloride sheets and polyethylene terephthalate (PET) sheets are often used as recording media. These sheets are recording media that have no or virtually no aqueous ink absorbent layer on the recording surface and are called non-absorbent recording media (recording media that have no aqueous ink absorbency) or less-absorbent recording media (recording media that have low aqueous ink absorbency). There is a demand for an ink jet recording method that can record directly on these recording media.

In order to record an image with an aqueous ink on a non-absorbent or less-absorbent recording medium described above (hereinafter collectively referred to as “non-absorbent recording medium”), the aqueous ink needs to be thickened to be immobilized on the non-absorbent recording medium. For example, moisture or the like may be evaporated from the ink on a non-absorbent recording medium to thicken the ink, or a reaction liquid that aggregates the ink components may be used to rapidly thicken the ink on the recording medium. The former, which does not require a reaction liquid, is advantageous in terms of running cost but requires a reduction in recording speed in order to produce high-quality images. The use of the latter method, which uses a reaction liquid, is under consideration, because of its superior productivity.

A recording method has been proposed in which a processing solution that aggregates ink components is brought into contact with the ink on the recording medium to allow recording medium that has virtually no ink absorption layer to have high productivity and to enables production of a clear image with little blurring (see Japanese Patent Laid-Open Nos. 2020-084102 and 2020-132802).

The inventors performed recording using the ink sets proposed in Japanese Patent Laid-Open Nos. 2020-084102, 2020-132802 and 2023-029244 on a non-absorbent recording medium. As a result, it was found that the inks proposed in Japanese Patent Laid-Open Nos. 2020-084102 and 2023-029244 were effective in suppressing image irregularities, but it was found that the abrasion resistance with water attached (hereinafter referred to as “water abrasion resistance”) was insufficient. It was also found that the ink proposed in Japanese Patent Laid-Open No. 2020-132802 has better water abrasion resistance than the ink set proposed in Japanese Patent Laid-Open No. 2020-084102 but still has room for improvement and has insufficient image irregularity suppression effect.

### SUMMARY

The present disclosure provides an ink jet recording method that advantageously suppresses image irregularities and can record images having excellent water abrasion resistance. The present disclosure also provides an ink jet recording apparatus for the ink jet recording method.

The present disclosure provides an ink jet recording method of recording an image on a recording medium by using an aqueous ink and an aqueous reaction liquid containing a reactant that reacts with the aqueous ink. The method includes a reaction liquid applying step of applying the aqueous reaction liquid to the recording medium; an ink applying step of applying the aqueous ink to the recording medium over at least a portion of an area to which the aqueous reaction liquid is applied; and a heating step of heating the recording medium having the applied aqueous ink and aqueous reaction liquid to a predetermined heating temperature T_{F} (° C.), wherein the recording medium has a water absorption amount from a start of contact to 30 msec^{1/2} according to Bristow method of 10 mL/m² or less, the reactant includes at least one acidic compound selected from the group consisting of an organic acid and an inorganic acid, the aqueous ink contains a pigment and a resin particle dispersed by action of an anionic group, the resin particle has an anionic group in an amount (μmol/g) of 75 μmol/g or more to 600 μmol/g or less, a content (% by mass) of the resin particle is 1.5 times or more than a content (% by mass) of the pigment on a mass basis, a content (% by mass) of a first water-soluble organic solvent having a vapor pressure of 3.1×10⁻⁵ kPa or less in the aqueous ink is 9.0% by mass or less based on the total mass of the aqueous ink and a content (% by mass) of a second water-soluble organic solvent having a relative permittivity of 28.0 or more and a vapor pressure of 4.0×10⁻³ kPa or less in the aqueous ink is 9.0% by mass or less based on the total mass of the aqueous ink, and the heating temperature T_{F} (° C.) of the recording medium and a glass transition temperature T_{G} (° C.) of the resin particle satisfy the following formula (1):

$${T}_{F} \geq ( {T}_{G} - 10 ) . \qquad ( 1 )$$

Further features of the present disclosure will become apparent from the following description of exemplary embodiments with reference to the attached drawings.

### BRIEF DESCRIPTION OF THE DRAWINGS

FIG. 1 is a perspective view schematically illustrating an embodiment of an ink jet recording apparatus according to the present disclosure.

FIG. 2 is a side view schematically illustrating an embodiment of an ink jet recording apparatus according to the present disclosure.

### DESCRIPTION OF THE EMBODIMENTS

The inventors first recorded a solid color image on a non-absorbent recording medium by using the ink and reaction liquid proposed in Japanese Patent Laid-Open No. 2020-132802. Since the ink does not penetrate a non-absorbent recording medium, ink dots are allowed to readily move, i.e., ink droplets gather due to lack of pinning properties, resulting in formation of an image having irregularities with a mixture of dark and light areas. The inventors assumed that the ink did not have enough aggregating property and tried various techniques to increase the aggregating property of the ink. As a result, they found that the aggregating property of ink is greatly affected by the aggregating property of the resin particle having an anionic group, which is used to provide abrasion resistance, and also found that it is important to set the amount of the anionic group in the resin particle to 75 μmol/g or more. The greater the amount of the anionic group in the resin particle, the greater the ionic repulsion in water and the higher the dispersion stability. However, due to fewer hydrophobic portions, such a resin particle is less susceptible to so-called solvation, in which dispersion stability is assisted by a water-soluble organic solvent, than a resin particle having the anionic group in a smaller amount. Thus, it is assumed that, during recording of an image, the reaction between the resin particle of the ink and the reactant of the reaction liquid occurs quickly and aggregation begins before the ink droplets begin to gather together to cause thickening of the ink and thus image irregularities can be suppressed.

Images were recorded using ink that contains the above-described resin particle having an anionic group in an amount of 75 μmol/g or more and a pigment, and it was found that image irregularities can be suppressed. However, when the water abrasion resistance of the image was checked by strongly rubbing the image with a cloth wetted with water, it was found that the water abrasion resistance was significantly inferior to that of images recorded using ink containing a resin particle having an anionic group in an amount of less than 75 μmol/g. In short, it was found that simply adjusting the amount of the anionic group in the resin particle cannot achieve both the image irregularity suppression and good water abrasion resistance.

In view of the above, the inventors searched for a mechanism that can improve water abrasion resistance even when the resin particle contains the anionic group in an amount of 75 μmol/g or more. First, when the images evaluated for water abrasion resistance were observed, it was confirmed that only the images recorded using the ink containing a resin particle having an anionic group in a large amount had the ink layer partly collapsed. The ink contains a resin particle to be dispersed by the action of the anionic group, and the resin particle enters between the pigment particles to form a strong film and improves water abrasion resistance. When a polyvalent metal salt is used as a reactant contained in the reaction liquid, the anionic group of the resin particle reacts with a polyvalent metal ion derived from the polyvalent metal salt as the reactant, and the anionic group bonds with the polyvalent metal ion. It is assumed that, when water is attached to the image, the above ionic bonds are slightly dissociated to increase the hydrophilicity. This trend was also confirmed when a cationic resin was used as the reactant.

The inventors predicted that, when an acid type inorganic or organic acid is used as a reactant, the anionic group becomes an acid type (H-type) having a lower degree of dissociation than when bonded to a polyvalent metal ion or to a cationic resin, reducing the hydrophilicity of the ink layer and improving the water abrasion resistance. A study revealed that, when recording was performed by using a reaction liquid containing at least one acidic compound among an organic acid and an inorganic acid, image irregularities were suppressed regardless of the kind of water-soluble organic solvent contained in the ink. However, it was found that water abrasion resistance was improved in some cases but not in others. The inventors observed the image that showed no improvement in water abrasion resistance and found that the ink layer was partly collapsed. The inventors have concluded that the following may be the reason why the reactivity by the acidic compound in the reaction liquid differs depending on the kind of water-soluble organic solvent contained in the ink.

When the amount of the anionic group in the resin particle contained in the ink is 75 μmol/g or more, the acidic compound, which is the reactant in the reaction liquid, reacts quickly with the resin particle in the ink as described above, resulting in thickening of the ink and suppression of image irregularities. It is not necessary that all the anionic group in the resin particle react. Reaction of a certain percentage of the anionic group in the resin particles causes the resin particle to aggregate, causing thickening of the ink. However, the hydrophilicity of the resin particle needs to be reduced to improve the water abrasion resistance of the image. If a large amount of the unreacted anionic group remains, the hydrophilicity of the resin particle is unlikely to decrease. It seems that the anionic group needs to react with the acidic compound in a greater proportion than in a proportion that can produce the effect of image irregularity suppression. The inventors assumed that the difference in the water abrasion resistance of the image depending on the kind of the water-soluble organic solvent contained in the ink may be due to the different degree of reaction between the anionic group of the resin particle in the ink and the acidic compound in the reaction liquid. They thought that the water-soluble organic solvent in the ink that was used when the water abrasion resistance of the image is low may have inhibited the reaction between the anionic group of the resin particle in the ink and the acidic compound in the reaction liquid.

Next, the inventors examined the relationship between the kind of the water-soluble organic solvent and the water abrasion resistance and found that the ink containing a water-soluble organic solvent having a relative permittivity of 28.0 or more and a vapor pressure of 4.0×10⁻³ kPa or less in a high proportion is inhibited from the reaction with the reaction liquid. The water-soluble organic solvent having a relative permittivity of 28.0 or more promotes ion dissociation and provides stabilization. The water-soluble organic solvent inhibits the reaction between the resin particle and acidic compound. However, if the above-described water-soluble organic solvent evaporates during the drying process of the recording medium, such as a process of heating the recording medium having the applied ink and reaction liquid, the reaction is less likely to be inhibited. Thus, it was found that the vapor pressure of the water-soluble organic solvent is required to be more than 4.0×10⁻³ kPa. It was found that images having good water abrasion resistance can be produced if the content (% by mass) of the water-soluble organic solvent that has a relative permittivity of 28.0 or more and a vapor pressure of 4.0×10⁻³ kPa or less in the ink is 9.0% by mass or less based on the total mass of the ink.

The inventors also found that water-soluble organic solvent having a vapor pressure of 3.1×10⁵ kPa or less also causes the decrease in the water abrasion resistance of the image. The water-soluble organic solvent having a vapor pressure of 3.1×10⁻⁵ kPa or less is less likely to evaporate even after sufficient time has elapsed and tends to remain in the ink layer. If such a water-soluble organic solvent remains in the ink layer, the hydrophilicity of the ink layer as a whole increases, failing to improve the water abrasion resistance. For the desired water abrasion resistance, it was found that the content (% by mass) of the water-soluble organic solvent having a vapor pressure of 3.1×10⁻⁵ kPa or less in the ink should be 9.0% by mass or less based on the total mass of the ink.

The anionic group of the resin particle is made into an acid type (H-type) through reaction with the acidic compound to cause aggregation of the resin particle, but there is an upper limit to the amount of the anionic group in the resin particle, and the amount of the anionic group is required to be 600 μmol/g or less. If the amount of the anionic group in the resin particle is more than 600 μmol/g, the reaction between the anionic group of the resin particle and the acidic compound takes longer. Thus, the unreacted anionic group is likely to remain in the ink layer, failing to improve the water abrasion resistance.

As described above, image irregularities can be suppressed by aggregation caused by the reaction between the acidic compound and the resin particle, but the unreacted anionic group that did not react with the acidic compound remain in the ink layer. When the unreacted anionic group comes into contact with water, ionic dissociation of the unreacted anionic group causes the ink layer to collapse starting from the dissociated anionic group, resulting in a decrease in the water abrasion resistance. The inventors found that the water abrasion resistance of an image can be improved when the relationship between the heating temperature T_{F} (° C.) at which the recording medium having the applied ink and reaction liquid is heated and the glass transition temperature T_{G} (° C.) of the resin particle contained in the ink satisfies the following formula (1):

$${T}_{F} \geq ( {T}_{G} - 10 ) . \qquad ( 1 )$$

When the relationship in the above formula (1) is satisfied, the resin particle of the ink melts when the recording medium is heated, filling the voids created between the ink dots and unifying the ink layer. The unified ink layer prevents water from entering the ink layer, improving the water abrasion resistance of the image.

In addition, in the ink, a content (% by mass) of the resin particle is required to be 1.5 times or more a content of the pigment (% by mass) on a mass basis. If there are voids in the ink layer as described above, water can readily enter the ink layer. If the anionic group remaining in the ink layer are dissociated by water, the water abrasion resistance of the image decreases. When the content of the resin particle in the ink is 1.5 times or more the content of the pigment, the voids between ink dots is filled with the resin particle melted by heating, effectively reducing the possibility that water will enter the ink layer. If the resin particle content of the ink is less than 1.5 times the pigment content, the resin particle cannot sufficiently fill the voids between the ink dots, failing to prevent water from entering the ink layer and thus failing to improve the water abrasion resistance. Ink jet Recording Method, Ink jet Recording Apparatus and Set of Aqueous Ink and Aqueous Reaction Liquid

The ink jet recording method according to the present disclosure is a method of recording an image on a recording medium using an aqueous ink and an aqueous reaction liquid. The ink jet recording method includes a step of applying an aqueous reaction liquid to a recording medium (reaction liquid applying step) and a step of applying an aqueous ink to the recording medium over at least a portion of the area to which the aqueous reaction liquid is applied (ink applying step). This ink jet recording method further includes a step of heating the recording medium having the applied aqueous ink and aqueous reaction liquid (heating step).

The ink jet recording apparatus according to the present disclosure is an apparatus configured to record an image on a recording medium using an aqueous ink and an aqueous reaction liquid. The apparatus is suitable for the above-described recording method. This ink jet recording apparatus includes a unit (reaction liquid applicator) configured to apply an aqueous reaction liquid onto a recording medium and a unit (ink applicator) configured to apply an aqueous ink onto the recording medium over at least a portion of an area to which the aqueous reaction liquid is applied. This ink jet recording apparatus includes a unit (heater) configured to heat a recording medium having the applied aqueous ink and aqueous reaction liquid. The recording method and the recording apparatus according to this disclosure do not require curing of the image by application of, for example, active energy rays.

The set of an aqueous ink and an aqueous reaction liquid in the present disclosure is used in an ink jet recording method in which images are recorded using an aqueous ink and an aqueous reaction liquid, and the set can be used in the above-described recording method. The set may be a set of multiple ink cartridges independently containing the corresponding inks (reaction liquids) or be in the form of an ink cartridge integrally including multiple ink reservoirs containing the corresponding inks (reaction liquids). The set in the present disclosure should not be limited to the above form and may be in any form that allows the ink and the reaction liquid to be used in combination.

The above-described recording medium is a recording medium having a water absorption amount after 30 msec^{1/2} from a start of contact according to Bristow method is 10 mL/m² or less (a less-absorbent or non-absorbent recording medium). The aqueous reaction liquid contains a reactant that reacts with an aqueous ink. The reactant contains at least one acidic compound selected from the group consisting of an organic acid and an inorganic acid. The above-described aqueous ink further contains a pigment and resin particle dispersed by action of an anionic group. The resin particle has the anionic group in an amount (μmol/g) of 75 μmol/g or more to 600 μmol/g or less. The content (% by mass) of the resin particle is 1.5 times or more the content (% by mass) of the pigment on a mass basis. Furthermore, a content (% by mass) of a first water-soluble organic solvent having a vapor pressure of 3.1×10⁻⁵ kPa or less in the aqueous ink is 9.0% by mass or less based on the total mass of the aqueous ink. Furthermore, a content (% by mass) of a second water-soluble organic solvent having a relative permittivity of 28.0 or more and a vapor pressure of 4.0×10⁻³ kPa or less in the aqueous ink is 9.0% by mass or less based on the total mass of the aqueous ink. The heating temperature T_{F} (C) of the recording medium in the heating step of the above-described ink jet recording method or in the heater of the ink jet recording apparatus and the glass transition temperature T_{G} (° C.) of the resin particle satisfy the relationship indicated by the following formula (1):

$${T}_{F} \geq ( {T}_{G} - 10 ) . \qquad ( 1 )$$

Hereinafter, the ink jet recording method and the ink jet recording apparatus (hereinafter may be simply referred to as “recording method and recording apparatus”) will be described in detail.

### Ink Applying Step and Reaction Liquid Applying Step

The recording method according to the present disclosure includes a reaction liquid applying step of applying a reaction liquid onto a recording medium and an ink applying step of applying ink onto the recording medium over at least a portion of the area to which the reaction liquid is applied. As the ink applicator of the recording apparatus, an ink jet recording head is used. As the reaction liquid applicator of the recording apparatus, a unit configured to apply the reaction liquid to the recording medium using a coating method that uses any type of coater and roller may be used other than the ink jet recording head. In an embodiment of the recording method and the recording apparatus, an image can be recorded by the ink and reaction liquid ejected from an ink jet recording head onto the recording medium. Thus, in an embodiment of the recording apparatus, an ink jet recording head can be used as the ink applicator and the reaction liquid applicator. Ink and a reaction liquid may be ejected from different recording heads to record an image, or ink and a reaction liquid may be ejected from different rows of outlets of a single recording element substrate to record an image.

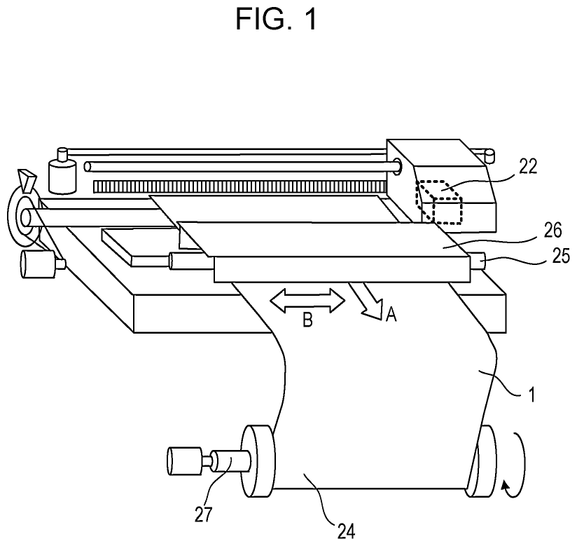

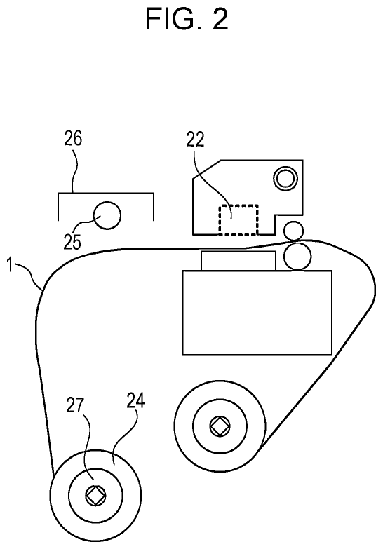

FIG. 1 is a perspective view schematically illustrating an embodiment of an ink jet recording apparatus according to the present disclosure. FIG. 2 is a side view schematically illustrating an embodiment of an ink jet recording apparatus according to the present disclosure. As illustrated in FIGS. 1 and 2, the recording apparatus in this embodiment includes an ink jet recording head 22 that ejects ink. The recording head 22 is a recording head that ejects ink through the action of thermal energy. A recording head that ejects ink through the action of thermal energy applies electrical pulses to the electrothermal conversion element to impart thermal energy to the ink, causing the ink to be ejected through the nozzle. In this example, the recording head that ejects ink through the action of thermal energy is used as an example, but a recording head that ejects ink through action of mechanical energy may also be used. The recording head may include a structure that heats the aqueous ink ejected from the recording head (temperature regulator). When the recording head includes a temperature regulator, the heating temperature of ink ejected from the recording head is preferably 35° C. or more to 70° C. or less.

### Heating Step

The recording method includes a heating step of heating (heat treating) the recording medium having the applied ink and reaction liquid to a predetermined heating temperature T_{F} (C). Heating the recording medium having the applied ink and reaction liquid promotes formation of a film by the resin particle, resulting in recording of an image having excellent water abrasion resistance.

Examples of a unit configured to heat a recording medium include a known warmer such as a heater, an air blower using blasts of air such as a dryer and a combination of them. In other words, the ink jet recording apparatus includes a structure (heater) that heats the recording medium having the applied ink and reaction liquid to a predetermined heating temperature T_{F} (° C.). Examples of the heater include the above warmer, the air blower and the combination of them. Examples of the heat-treating method include a method of applying heat to a surface (rear surface) of the recording medium opposite from the recording surface (ink receiving surface) by, for example, a heater, a method of applying warm air or hot air to the recording surface of the recording medium and a method of applying heat to the recording surface or the rear surface by an infrared heater. These methods may be used in combination.

The heating temperature T_{F} (° C.) of the recording medium having the applied ink and reaction liquid is preferably 50° C. or more to 90° C. or less, which can improve the abrasion resistance of the image. Here, the heating temperature of the recording medium having the applied ink and reaction liquid may also be referred to as a temperature of the recorded image or a temperature of the recording medium having the applied ink and reaction liquid reached by heating. The heating temperature T_{F} (° C.) of the recording medium having the applied ink and reaction liquid may be determined by using a sensor located at a position corresponding to the heating unit of the recording apparatus or may be determined using the relationship between the amount of heat set for the type of ink and the temperature of the recording medium.

The difference (T_{F}-T_{G}) between the heating temperature T_{F} (° C.) of the recording medium and the glass transition temperature T_{G} (° C.) of the resin particle is −10° C. or more as indicated by the formula (1), preferably 0° C. or more (i.e., the heating temperature T_{F} is greater than or equal to the T_{G} of the resin particle). The above difference (T_{F}-T_{G}) of −10° C. or more allows easy fusion of the resin particle, improving the water abrasion resistance of the image. The difference (T_{F}-T_{G}) between the heating temperature T_{F} (° C.) and the glass transition temperature T_{G} (C) is preferably +50° C. or less, more preferably +30° C. or less, and even more preferably +20° C. or less.

The amount of heat ((W·h)/g) to be applied to the ink on the recording medium is preferably 2 (W·h)/g or more. The application of heat of 2 (W·h)/g or more to the ink can sufficiently dry the ink on the recording medium, improving the water abrasion resistance of the recorded image. The amount of heat ((W·h)/g) to be applied to the ink on the recording medium is preferably 10 (W·h)/g or more. The amount of heat applied to the ink can be determined as follows. First, the power A (W) applied to the heater that heats the recording medium is determined. The recording area B (m²/h) per unit time recorded by the recording apparatus and the ink consumption C (g/m²) per unit area for this recording are also determined. The amount of heat ((W·h)/g) applied to the ink on the recording medium is calculated by using these values based on a formula (2) below:

$$Amount of heat applied to ink on a recording medium ( ( W \cdot h ) / g ) = A ( W ) / B ( {m}^{2} / h ) / C ( g / {m}^{2} ) . \qquad ( 2 )$$

In the recording apparatus illustrated in FIGS. 1 and 2, a heater 25 supported by a frame (not illustrated) is located downstream in the sub-scanning direction A from a position where the recording head 22 reciprocates in the main scanning direction B. The recording medium 1 having the applied ink can be heated by the heater 25. Specific examples of the heater 25 include a sheathed heater and a halogen heater. The heater 25 is covered by a heater cover 26. The heater cover 26 allows the heat generated by the heater 25 to be efficiently applied to the recording medium 1. The heater cover 26 also protects the heater 25. The recording medium 1 having the ink ejected from the recording head 22 is wound up by a take-up spool 27 to form a wounded medium 24 in the form of a roll. Recording Medium

The recording method and the recording apparatus according to the present disclosure use a less-absorbent or non-absorbent recording medium (less to non-absorbent recording medium). The less- to non-absorbent recording medium is a recording medium that has a water absorption amount after 30 msec^{1/2} from a start of contact of 10 mL/m² or less according to Bristow Method described in “Paper and Cardboards-Liquid Absorption Test Method” in JAPAN TAPPI Pulp and Paper Test Methods No. 51. In other words, the recording method and the recording apparatus according to the present disclosure use a recording medium having a water absorption amount after 30 msec^{1/2} from a start of contact according to Bristow method of 0 mL/m² or more to 10 mL/m² or less. Herein, a recording medium that satisfies the above water absorption amount condition is defined as a “less to non-absorbent recording medium”. A recording medium for ink jet recording (e.g., glossy paper and matte paper) having a coating layer (ink receptive layer) formed of an inorganic particle and plain paper not having a coating layer are “absorbent recording media” that have the above water absorption amount of more than 10 mL/m².

Examples of the less to non-absorbent recording medium include a plastic film, a recording medium having a plastic film bonded to a recording surface of a base material and a recording medium having an organic resin layer on a recording surface of a base material containing cellulose pulp. Among them, a plastic film can be particularly used, and a recording medium having an organic resin layer on a recording surface of a base material containing cellulose pulp can also be used.

When the ink containing the resin particle is applied to a non-absorbent recording medium, water and components such as a water-soluble organic solvent evaporate, resulting in concentration of the resin particle. This promotes fusion between the concentrated resin particles, increasing the recorded image strength. In contrast, when the ink is applied to a recording medium having high absorption of liquid components (absorptive recording medium), the fusion between the resin particles is less promoted, failing to improve the image strength. In this specification, a recording medium means a recording medium on which an image as a recording object is to be recorded, not a transfer member.

### Reaction Liquid

The recording method according to the present disclosure includes a reaction liquid applying step of applying a reaction liquid, which contains a reactant that reacts with an aqueous ink, onto a recording medium. In particular, the reaction liquid applying step can be performed before the ink applying step, or the ink applying step and the reaction liquid applying step can be performed in parallel. Hereinafter, components of the reaction liquid will be described in detail.

### Reactant

The reactant reacts with the ink and aggregates the components in the ink (resin and components having an anionic group such as a self-dispersing pigment) when brought into contact with the ink and contains a reactant. Due to the presence of a reactant, when the ink comes into contact with the reactant on the recording medium, the state of existence of the component having an anionic group in the ink is destabilized, promoting ink aggregation. The reactant contains an acid-type inorganic acid or an organic acid. In other words, the reactant contains at least one acidic compound selected from the group consisting of an organic acid and an inorganic acid. The content (% by mass) of the acidic compound contained in the reaction liquid is preferably 0.10% by mass or more to 15.0% by mass or less, more preferably 0.20% by mass or more to 10.0% by mass or less based on the total mass of the reaction liquid. The content is particularly preferably 0.20% by mass or more to 5.0% by mass or less.

An inorganic acid dissociates readily in water, releasing protons and causing an anionic group of a component present in the ink to aggregate in an acid form. An inorganic acid is also called a mineral acid. Examples of the inorganic acid include hydrochloric acid, nitric acid, sulfuric acid and phosphoric acid. One or more of these can be used.

The reaction liquid containing an organic acid has a buffering capacity in an acidic region (less than pH 7.0, preferably pH 2.0 to pH 5.0) and thus efficiently makes the anionic group of the component in the ink into an acid form for aggregation. Examples of the organic acid include monocarboxylic acids such as formic acid, acetic acid, propionic acid, butyric acid, pivalic acid, benzoic acid, glycolic acid, lactic acid, salicylic acid, pyrrole carboxylic acid, pyrrolidone carboxylic acid, furan carboxylic acid, picolinic acid, nicotinic acid, thiophene carboxylic acid, levulinic acid, coumaric acid and salts thereof, dicarboxylic acids such as oxalic acid, malonic acid, succinic acid, glutaric acid, adipic acid, maleic acid, fumaric acid, itaconic acid, sebacic acid, phthalic acid, malic acid, tartaric acid and salts and hydrogen salts thereof, tricarboxylic acids such as citric acid, trimellitic acid and salts and hydrogen salts thereof and tetracarboxylic acid such as pyromellitic acids and salts and hydrogen salts thereof. When an organic acid is used as a reactant, the content (% by mass) of the organic acid contained in the reaction liquid is preferably 1.0% by mass or more to 50.0% by mass or less based on the total mass of the reaction liquid.

Among acidic compounds, an organic acid can be particularly used because it is more likely to increase the water abrasion resistance of images. In other words, the acidic compound in the aqueous reaction liquid can be an organic acid. The organic acid, which has buffering capacity, reacts with the anionic group of the resin particle slowly, and the unreacted resin particle is less likely to remain.

Among organic acids, an organic acid having a pKa of 4.9 or less can be particularly used. In other words, a pKa of the organic acid is preferably 4.9 or less. A pKa indicates how easily a proton dissociates from an acid and is the negative of the normal logarithm (pKa=−log ₁₀Ka) of the acid dissociation constant (Ka). Here, if an organic acid has more than one pKa, a first pKa is used. This is because the amount of acid dissociated in the reaction liquid is mostly determined by the first pKa. The organic acid having a pKa of 4.9 or less is highly effective to aggregate the resin particle, resulting in more advantageous suppression of image irregularities. Furthermore, when the resin particle is dispersed by the action of a carboxylic acid group, which is the anionic group, the organic acid having a pKa of 2.8 or more can be particularly used. When the organic acid has a pKa of 2.8 or more, the above-described effect of the slow reaction of the organic acid can be readily achieved.

The pKa of the organic acid is preferably less than or equal to that of the anionic group of the resin particle in the ink. When the organic acid has a pKa of less than or equal to that of the anionic group of the resin particle, the reaction between the resin particle and the organic acid is likely to proceed at a moderate speed, and the proportion of the resin particle remaining unreacted can be kept low, resulting in a further improvement of the water abrasion resistance of the image. Here, if the anionic group of the resin particle has more than one pKa, a first pKa (pKa₁) is used, because a first acid dissociation constant is mostly responsible for the reactivity with the organic acid.

The reaction liquid may contain a reactant other than the above-described acidic compounds (other reactants). Examples of other reactants include polyvalent metal salts and cationic resins. One or more of these may be used.

When the reactant further contains a polyvalent metal salt in addition to the acidic compound, a polyvalent metal salt having a solubility (g/100 mL) in 20° C. water of 70.0 g/100 mL or less can be particularly used to further suppress the image irregularities and further improve the water abrasion resistance. When the reactant further contains a cationic resin in addition to the above-described acidic compound, a cationic resin having a cationicity (meq/g) of 3 meq/g or more to 7 meq/g or less can be particularly used to further suppress the image irregularities and improve the water abrasion resistance.

In this specification, the cationicity (meq/g) of the cationic resin is the value at pH7.0 defined as the colloid equivalent value obtained using a potassium polyvinyl sulfate reagent. Specifically, a colloid titration method is performed using an automatic potentiometric titrator (“AT-510” (trade name) available from Kyoto Electronics Manufacturing Co., Ltd.) and a 1/400N (mol/L) potassium polyvinyl sulfate solution (“N/400 PVSK Solution” (trade name) available from FUJIFILM Wako Pure Chemical Corporation) as a titrant reagent. The cationicity is then calculated by using the formula: cationicity (meq/g)=(titration volume of 1/400N potassium polyvinyl sulfate solution (mL)/400)/(cationic resin sample volume (g)×sample concentration (% by mass)). The apparatus used to calculate the cationicity should not be limited to the above. The cationicity (meq/g) of each cationic resin used in the examples below was measured by the above-described method.

The acidic compound aggregates the anionic group in the ink by making the anionic group into an acid type (H-type) to be insoluble, and thus has not so high ability as an aggregating agent. Reagents having multiple reaction points in one molecule, such as polyvalent metal ions in polyvalent metal salts and cationic resins, form a three-dimensional molecular chain entanglement (network) when reacted with a resin particle, and the viscosity after aggregation is likely to increase.

Polyvalent metal salts and cationic resins improve aggregating properties and advantageously suppress image irregularities. However, the reactant of a polyvalent metal salt or a cationic resin with the anionic group of the resin particle has higher solubility than the reactant of the acidic compound with the anionic group of the resin particle. Thus, to achieve both water resistance and abrasion resistance at a sufficiently high level, a resin particle that reacts with both reactants can be used. For this purpose, the solubility (g/100 mL) of the polyvalent metal salt in 20° C. water is preferably 70.0 g/100 mL or less. The cationic resin preferably has a cationicity of 3 meq/g or more to 7 meq/g or less at pH 7.0 defined as the colloidal equivalent value obtained using a polyvinyl potassium sulfate reagent.

As the solubility of a polyvalent metal salt increases, dissociation in water is likely to become larger and the reaction rate is likely to increase. When a polyvalent metal salt is used as a reactant together with the acidic compound, a polyvalent metal salt having a solubility of 70.0 g/100 mL or less in 20° C. water is used so that the resin particle also reacts with the acidic compound. To suppress the image irregularities, the above solubility of the polyvalent metal salt is preferably 3.0 g/100 mL or more.

In the cationic resin, the number of reaction points increases as the cationicity increases, and if the cationicity is too high, the cationic resin tends to react preferentially with one resin particle, which tends to result in an increase in solubility. However, to suppress image irregularities, a cationic resin having a certain cationicity can be particularly used. Thus, when a cationic resin is used as a reactant together with an acidic compound, the cationicity of the cationic resin is preferably 3 meq/g or more to 7 meq/g or less at pH 7.0.

Examples of the polyvalent metal ion, which constitutes a polyvalent metal salt, include divalent metal ions such as Ca²⁺, Cu²⁺, Ni²⁺, Mg²⁺, Sr²⁺, Ba²⁺ and Zn²⁺ and trivalent metal ions, such as Fe³⁺, Cr³⁺, Y³⁺ and Al³⁺. To add a polyvalent metal ion in the reaction liquid, a water-soluble polyvalent metal salt (which can be a hydrate) constituted by combining a polyvalent metal ion with an anion can be used. Examples of the anion include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃^{-m}, PO₄³⁻, HPO₄²⁻ and H₂PO₄⁻ and organic anions such as HCOO⁻, (COO⁻)₂, COOH(COO⁻), CH₃COO⁻, C₂H₅COO⁻, CH₃CH(OH)COO⁻, C₂H₄(COO⁻)₂, C₆H₅COO⁻, C₆H₄(COO⁻)₂ and CH₃SO₃⁻.

Examples of the polyvalent metal salt having a solubility of 70.0 g/100 mL or less in 20° C. water include calcium lactate (3.1 g/100 mL), calcium acetate (31.1 g/100 mL), magnesium sulfate (26.9 g/100 mL), aluminum chloride (46.0 g/100 mL), magnesium acetate (53.4 g/100 mL) and magnesium nitrate (69.0 g/100 mL). The values in parentheses above represent solubility in 20° C. water (g/100 mL).

The polyvalent metal salt can be a divalent metal ion, because it is easier to balance the reactivity between the anionic group of the resin particle and the polyvalent metal salt and the reactivity between the anionic group of the resin particle and the acidic compound. Among them, salts using magnesium ions (Mg²⁺) can be particularly used, because the degree of dissociation of the ionic bond with the anionic group is not too high and they have excellent water abrasion resistance.

When a polyvalent metal ion is used as a reactant, the content (% by mass) in terms of the polyvalent metal contained in the reaction liquid is preferably 1.0% by mass or more to 20.0% by mass or less, based on the total mass of the reaction liquid. In this specification, the “content (% by mass) of the polyvalent metal salt” contained in the reaction liquid when the polyvalent metal salt is hydrate means the “content (% by mass) of anhydrous polyvalent metal salt” excluding water as hydrate. Furthermore, in the aqueous reaction liquid, the content of the polyvalent metal salt (in moles) is preferably 0.60 times or more to 10.0 times or less the content of the acidic compound (in moles) on a molar basis. When the above molar ratio is 0.60 times or more, the effect of image irregularity suppression can be further improved. In contrast, when the above molar ratio is 10.0 times or less, the water abrasion resistance of the image can be further improved.

Examples of the cationic resin include a resin having a primary to tertiary amine structure and a resin having a quaternary ammonium salt structure. Specific examples include resins having structures of vinylamine, allylamine, vinylimidazole, vinylpyridine, dimethylaminoethyl methacrylate, ethyleneimine, guanidine, diallyldimethylammonium chloride and alkylamine-epichlorohydrin condensation. In order to improve the solubility in the reaction liquid, the cationic resin may be used in combination with an acidic compound, or the cationic resin may be subjected to quaternarization treatment. When a cationic resin is further used as a reactant, the content (% by mass) of the cationic resin contained in the reaction liquid is preferably 0.10% by mass or more to 10.0% by mass or less based on the total mass of the reaction liquid.

In the aqueous reaction liquid, the content (% by mass) of the cationic resin is preferably 1.25 times or more to 12.60 times or less the content (% by mass) of the acidic compound on a mass basis. When the above mass ratio is 1.25 times or more, the ratio of the cationic resin increases and the effect of resin particles forming a network can be readily obtained, further suppressing image irregularities. In contrast, when the above mass ratio is 12.60 times or less, the acidic compound can be present at a certain ratio to the cationic resin, readily lowering the hydrophilicity of the ink layer and thus enhancing the water abrasion resistance of the image.

The weight average molecular weight of the cationic resin is preferably 15,000 or less, more preferably 10,000 or less. When the weight average molecular weight of the cationic resin is 15,000 or less, the formation of an aggregation network with resin particles is more likely to be sufficient, further suppressing image irregularities. The weight average molecular weight of the cationic resin is preferably 1,000 or more. The weight average molecular weight of the cationic resin is determined in terms of polystyrene by gel permeation chromatography (GPC).

The cationic resin can have a quaternary amine structure as the cationic moiety. A cationic resin having a quaternary amine structure is less likely to lose their cationicity even when the pH is lowered by the addition of acid than a cationic resin having a primary to tertiary amine structure without the quaternary amine structure, thus improving reactivity with the resin particle.

### Aqueous Medium

The reaction liquid is an aqueous reaction liquid containing at least water as an aqueous medium. The aqueous medium contained in the reaction liquid can be the same as that exemplified below as the aqueous medium that can be contained in the ink. The content (% by mass) of water contained in the reaction liquid is preferably 50.0% by mass or more, more preferably 60.0% by mass or more, further more preferably 90.0% by mass or less based on the total mass of the reaction liquid.

### Other Components

The reaction liquid may contain various other components as needed. Examples of the other components may be the same as those exemplified below as other components that can be contained in the ink.

### Physical Properties of Reaction Liquid

The reaction liquid is an aqueous reaction liquid applicable to the ink jet system. Thus, in view of reliability, the physical properties of the first reaction liquid may be controlled appropriately. Specifically, the surface tension of the reaction liquid at 25° C. is preferably 20 mN/m or more to 60 mN/m or less. Furthermore, the viscosity of the reaction liquid at 25° C. is preferably 1.0 mPa·s or more to 10.0 mPa·s or less. The pH of the reaction liquid at 25° C. is preferably 1.7 or more to 7.0 or less, more preferably 2.0 or more to 4.0 or less.

### Ink

The recording method according to the present disclosure includes an ink applying step of applying ink onto a recording medium over at least a portion of the area to which the reaction liquid is applied. The ink used in the recording method is an aqueous ink for jet ink printing containing a pigment and a resin particle that are dispersed by action of an anionic group. Hereinafter, components of the ink will be described in detail.

### Pigment

The ink contains a pigment as a coloring material. The pigment content (% by mass) of the ink is preferably 0.1% by mass or more to 15.0% by mass or less, more preferably 1.0% by mass or more to 10.0% by mass or less based on the total mass of the ink.

Specific examples of the pigment include an inorganic pigment, such as carbon black and titanium dioxide and an organic pigment, such as azo, phthalocyanine, quinacridone, isoindolinone, imidazolone, diketopyrrolopyrrole and dioxazine. The pigments may be used either alone or in combination.

The pigment may be, for example, a resin-dispersing pigment in which resin (resin dispersant) is used as a dispersant or a self-dispersible pigment having hydrophilic groups bonded to the surface of the pigment particle. Furthermore, the pigment may be a resin-bonded pigment in which an organic group including a resin is chemically bonded to the surface of the pigment particle and a microcapsule pigment in which the surface of the pigment particle is coated with a resin or other substances may be used. The above pigments in different dispersion types may be used in combination. Among them, a resin-dispersed pigment in which resin as a dispersant is physically adsorbed on the surface of the pigment particle can be chosen over a resin-bonded pigment and a microcapsule pigment. In other words, the pigment can be a pigment that is dispersed by the action of a resin dispersant.

A resin dispersant for dispersing a pigment in an aqueous medium can be one that can disperse the pigment in the aqueous medium by action of an anionic group. The resin dispersant may be a resin having an anionic group such as resins described below, particularly a water-soluble resin. The pigment content (% by mass) of the ink is preferably 0.3 times or more to 10.0 times or less the resin dispersant content on a mass basis.

The self-dispersing pigment may be one in which the anionic group such as a carboxylic acid group, a sulfonic acid group and a phosphoric acid group is bonded to the particle surface of the pigment directly or via another atomic group (—R—). The anionic group may be in either acid or salt form, and when in salt form, may be either partially dissociated or fully dissociated. When the anionic group is in salt form, examples of the cation that serves as a counter ion include an alkali metal cation, ammonium and organic ammonium. Specific examples of another atomic group (—R—) include a linear or branched alkylene group having 1 to 12 carbon atoms, an arylene group, such as a phenylene group and a naphthylene group, a carbonyl group, an imino group, an amide group, a sulfonyl group, an ester group and an ether group. The atomic group (—R—) may be a combination of these groups.

### Resin Particle

The ink contains a resin particle that is dispersed by action of an anionic group. The ink, which contains a resin particle dispersed by action of an anionic group, reacts with the reactant when brought into contact with the reactant on the surface of the recording medium. Then, the resin particle having the anionic group forms a large aggregate, suppressing image irregularities and providing the ink with film strength necessary for water abrasion resistance.

The content (% by mass) of the resin particle in the ink is required to be 1.5 times or more the content (% by mass) of the pigment on a mass basis. When the content of the resin particle in the ink is 1.5 times or more the content of the pigment, the resin particle fills voids between ink dots when melted by heating, reducing the possibility that water will enter the ink layer. If the resin particle content of the ink is less than 1.5 times the pigment content, the resin particle cannot sufficiently fill the voids between ink dots, failing to reduce the possibility that water will enter the ink layer and to improve water abrasion resistance. The resin particle content (% by mass) of the ink is preferably 1.7 times or more the pigment content (% by mass), more preferably 40.0 times or less the pigment content (% by mass).

The term “resin particle” as used herein refers to a resin that can be dispersed in an aqueous medium and present in an aqueous medium while having a particle size. The resin particle is a resin that does not dissolve in the aqueous medium constituting the ink. Specifically, the resin particle is a resin that can be present in the aqueous medium in the form of a particle whose diameter can be measured by dynamic light scattering. The resin particle is present in a dispersed state in the ink, i.e., in the form of a resin emulsion. The resin particle may also contain a color material (such as a dye, pigment and invisible color material that emits color due to fluorescence).

Whether or not a certain resin is the “resin particle” can be determined according to the following method. First, a liquid containing a resin neutralized with an alkali (such as sodium hydroxide and potassium hydroxide) (resin solid content: 10% by mass) equivalent to an acid value is prepared. Next, this liquid is diluted 10-fold (on the volume basis) with pure water to prepare a sample solution. Then, the particle size of the resin in the sample solution is measured by dynamic light scattering. If a particle having a particle size is measured, the resin is determined to be “resin particle”. A particle size distribution measuring device using dynamic light scattering may be a particle size analyzer (for example, “UPA-EX150” (trade name) available from NIKKISO CO., LTD.). This measurement can be performed, for example, under the following conditions: SetZero: 30 seconds, number of measurements: 3 times, measurement time: 180 seconds, shape: true spherical shape and refractive index: 1.59. The particle size distribution measuring device and the measurement conditions should not be limited to the above. The neutralized resin is used to determine the particle size, because it can be confirmed that the particle is formed even if formation of the particle is difficult due to sufficient neutralization. The resin that is in the form of particle even under such a condition is present in the form of particle in the aqueous ink.

Examples of the resin constituting the resin particle include an acrylic resin, a urethane resin, an olefin resin and a polyester resin. Among them, an acrylic resin can be particularly used.

### Acrylic Resin

The acrylic resin can be a resin having a hydrophilic unit and a hydrophobic unit as constitution units. Among them, a resin having a hydrophilic unit derived from (meth)acrylic acid and a hydrophobic unit derived from at least one monomer selected from the group consisting of a monomer having an aromatic ring and a (meth)acrylic acid ester monomer can be particularly used. In particular, the acrylic resin can be one having a hydrophilic unit derived from (meth)acrylic acid and a hydrophobic unit derived from at least one monomer selected from the group consisting of styrene and α-methylstyrene.

The hydrophilic unit is a unit that has a hydrophilic group such as an anionic group. The hydrophilic unit can be formed, for example, through polymerization of a hydrophilic monomer having a hydrophilic group. Specific examples of the hydrophilic monomer having a hydrophilic group include an acidic monomer having a carboxy group, such as (meth)acrylic acid, itaconic acid, maleic acid and fumaric acid and an anionic monomer such as anhydrides and salts of these acidic monomers. Examples of the cation constituting the salt of an acidic monomer include a lithium ion, a sodium ion, a potassium ion, an ammonium ion and an organic ammonium ion.

The hydrophobic unit is a unit that does not have a hydrophilic group such as an anionic group. The hydrophobic unit can be formed, for example, through polymerization of a hydrophobic monomer not having a hydrophilic group such as an anionic group. Specific examples of the hydrophobic monomer include monomers having an aromatic ring, such as styrene, α-methylstyrene and benzyl (meth)acrylate and (meth)acrylic ester monomers, such as methyl (meth)acrylate, butyl (meth)acrylate and 2-ethylhexyl (meth)acrylate.

### Urethane Resin

A urethane resin can be produced, for example, through reaction between polyisocyanate and polyol. Furthermore, a chain extender may also be reacted. Examples of the olefin resin include polyethylene and polypropylene.

### Polyester Resin

A polyester resin includes a unit derived from a polyhydric alcohol and a unit derived from a polycarboxylic acid. Examples of the polyhydric alcohol that becomes a unit derived from a polyhydric alcohol, which constitutes the polyester resin, include dihydric to tetrahydric alcohols. Examples of the structure of the polyhydric alcohol include polyhydric alcohols having an aliphatic group, polyhydric alcohols having an aromatic group and sugar alcohols. Specific examples of the polyhydric alcohol include dihydric alcohols such as ethylene glycol [1,2-ethanediol], neopentyl glycol [2,2-dimethyl-1,3-propanediol], 1,3-propanediol, 1,4-butanediol, benzenediol and 2,2-bis(4-hydroxyphenyl) propane [bisphenol A], trihydric alcohols such as glycerin, trimethylolethane and trimethylolpropane and tetrahydric alcohols such as pentaerythritol. In addition, as the polyhydric alcohol, an oligomer (a low molecular weight polymer having a molecular weight of 1,000 or less) can also be used.

For easy adjustment of the weight average molecular weight of the polyester resin, polyhydric alcohols such as dihydric alcohols and trihydric alcohols can be used. From the viewpoint of the structure, polyhydric alcohols having an aliphatic group and polyhydric alcohols having an aromatic group can be used. As the polyhydric alcohols having an aliphatic group, linear or branched polyhydric alcohols having an aliphatic group having 1 to 6 carbon atoms can be particularly used.

Examples of the polycarboxylic acid that becomes a unit derived from the polycarboxylic acid, which constitutes the polyester resin by reaction, include dihydric to tetrahydric polycarboxylic acids. Examples of the structure of the polycarboxylic acid include polycarboxylic acids having an aliphatic group, polycarboxylic acids having an aromatic group and nitrogen-containing polycarboxylic acids. Specific examples of the polycarboxylic acid include dicarboxylic acids such as glutaric acid, adipic acid, terephthalic acid, isophthalic acid and 2,6-naphthalenedicarboxylic acid, tricarboxylic acids such as trimellitic acid and tetracarboxylic acids such as ethylenediaminetetraacetic acid. In addition, as the polycarboxylic acid, an oligomer (a low molecular weight polymer having a molecular weight of 1,000 or less) can also be used.

For easy adjustment of the weight average molecular weight and the acid value of the polyester resin, polycarboxylic acids such as dicarboxylic acids and tricarboxylic acids can be used. From the viewpoint of the structure, carboxylic acids having an aliphatic group or carboxylic acids having an aromatic group can be used. In particular, adipic acid, terephthalic acid, isophthalic acid and trimellitic acid can be used. Among them, two or more of these can be used in combination.

The anionic group is a group contained in a unit derived from the monomer described above, and examples of the anionic group include a carboxylic acid group, a sulfonic acid group, a phosphoric acid group and a phosphonic acid group. The resin particle may be dispersed in the ink by the action of one or more of these anionic groups. Among them, a carboxylic acid group can be particularly used as the anionic group. The carboxylic acid group, which has a lower degree of dissociation than other anionic groups such as a sulfonic acid group and a phosphonic acid group, makes it easier to produce images having more excellent water abrasion resistance.

The content (% by mass) of the resin particle contained in the ink is preferably 2.0% by mass or more to 50.0% by mass or less, more preferably 2.0% by mass or more to 20.0% by mass or less based on the total mass of the ink.

### Method of Producing Resin Particle

The resin particle can be produced according to a known method, such as an emulsion polymerization method, a miniemulsion polymerization method, a seed polymerization method and a phase-inversion emulsification method. Among them, an emulsion polymerization method and a seed polymerization method, which can produce a resin particle having a more uniform particle diameter, can be particularly used. The use of the resin particle having a more uniform particle diameter can further stabilize ink ejection by using the ink jet technology.

The weight average molecular weight of the resin constituting the resin particle is preferably 1,000 or more to 3,000,000 or less, more preferably 100,000 or more to 3,000,000 or less. The weight average molecular weight of the resin constituting the resin particle can be determined in terms of polystyrene by gel permeation chromatography (GPC). The volume average particle diameter of the resin particle (cumulative 50% particle diameter of the resin particle on a volumetric basis: D50), as measured by dynamic light scattering, is preferably 50 nm or more to 500 nm or less. The cumulative 50% particle diameter (D50) of a volumetric particle size distribution of the resin particle can be measured using a particle size distribution analyzer using dynamic light scattering (for example, “UPA-EX150” (trade name) available from NIKKISO CO., LTD.).

### Thermal Properties of Resin Particle

To improve image adhesion and abrasion resistance, the resin particle needs to satisfy the relationship between the heating temperature T_{F} (° C.) of the recording medium having the applied ink and reaction liquid and the glass transition temperature T_{G} (° C.) of the resin particle, which is indicated by the following formula (1):

$${T}_{F} \geq ( {T}_{G} - 10 ) . \qquad ( 1 )$$

The characteristics of the above formula (1) are the thermal characteristics necessary for the resin particle in the ink to be sufficiently coated under the heating temperature T_{F} (° C.) of the recording medium in the heating step (by a heater). The glass transition temperature T_{G} (° C.) of the resin particle is preferably 0° C. or more to 100° C. or less, more preferably 30° C. or more, furthermore preferably 90° C. or less. When the glass transition temperature T_{G} (° C.) of the resin particle is 30° C. or more, the ink layer formed is moderately hard, and the water abrasion resistance can be further improved. The glass transition temperature (° C.) of the resin particle can be measured using a differential scanning calorimeter (DSC). The glass transition temperatures of the resin particles used in Examples were measured by DSC.

### Physical Properties

The resin particle has the anionic group in an amount (μmol/g) of 75 μmol/g or more to 600 μmol/g or less. In particular, the amount of the anionic group in the resin particle is preferably 95 μmol/g or more to 270 μmol/g or less. This value is the density of the anionic group present in the resin particle (in micromolar units) per unit mass of the resin particle. When the amount of the anionic group in the resin particle is 95 μmol/g or more, image irregularities can be further suppressed. On the other hand, if the amount of the anionic group in the resin particle is 270 μmol/g or less, the water abrasion resistance of the image can be further improved. The following describes the method of extracting the resin particle from ink for analysis and verification. Resin particles extracted from a water dispersion liquid and the like can also be analyzed and verified in the same way.

### (i) Extraction of Resin Particle

The resin particle can be separated and extracted from the ink containing the resin particle by a density gradient centrifugation method. In a density gradient sedimentation velocity method of the density gradient centrifugation method, the resin particle is separated and extracted by the difference in sedimentation coefficient between components. In a density gradient sedimentation equilibrium method of the density gradient centrifugation method, the resin particle is separated and extracted by the difference in density between components. The resin particle can be separated by this density gradient centrifugation method.

### (ii) Determination of Amount of Anionic Group

The amount of the anionic group in the resin particle can be determined by colloidal titration using a potential difference. In examples described below, an automatic potentiometric titrator (“AT-510” (trade name) available from Kyoto Electronics Manufacturing Co., Ltd.) equipped with a streaming potential titration unit (PCD-500) is used to determine the amount of the anionic group (μmol/g) in the resin particle according to a colloid titration method using a potential difference. In this case, the resin particle dispersion liquid at the time of measurement was adjusted to pH=8 to 9, and methylglycol chitosan was used as the titrant reagent.

### Other Resins

In addition to the resin particle described above, which is dispersed by action of the anionic group, the ink can contain other resins. Hereinafter, a resin other than the above-described resin particle dispersed by action of the anionic group may be simply described as a “resin”. The content (% by mass) of the resin contained in the ink is preferably 0.1% by mass or more to 20.0% by mass or less, more preferably 0.5% by mass or more to 15.0% by mass or less based on the total mass of the ink.

(i) A resin can be added to the ink to stabilize the dispersion state of a pigment, i.e., as a resin dispersant or a dispersant aid. (ii) A resin can also be added to improve various properties of the recorded image. The resin may be a block copolymer, a random copolymer, a graft copolymer or a combination thereof. The resin may be a water-soluble resin that can dissolve in an aqueous medium or a resin particle that is dispersed in an aqueous medium, i.e., the resin particle described above. The term “water-soluble resin” as used herein refers to a resin that can dissolve in the aqueous medium constituting the ink and specifically refers to a resin that can be present in the aqueous medium without forming a particle whose diameter can be measured by dynamic light scattering.

### Composition of Resin

Examples of the resin include an acrylic resin, a urethane resin and an olefin resin. Among them, an acrylic resin and a urethane resin can be particularly used, and an acrylic resin composed of a unit derived from (meth)acrylic acid or (meth)acrylate can be further particularly used.

The acrylic resin can be a resin having a hydrophilic unit and a hydrophobic unit as constitution units. Among them, a resin having a hydrophilic unit derived from (meth)acrylic acid and a hydrophobic unit derived from at least one monomer selected from the group consisting of a monomer having an aromatic ring and a (meth)acrylic acid ester monomer can be used. In particular, a resin having a hydrophilic unit derived from (meth)acrylic acid and a hydrophobic unit derived from at least one monomer selected from the group consisting of styrene and α-methylstyrene can be used. These resins are likely to interact with a pigment and thus can be suitably used as a resin dispersant that disperses the pigment.

The hydrophilic unit is a unit that has a hydrophilic group such as an anionic group. The hydrophilic unit can be formed, for example, through polymerization of a hydrophilic monomer having a hydrophilic group. Specific examples of the hydrophilic monomer having a hydrophilic group include acidic monomers having a carboxy group, such as (meth)acrylic acid, itaconic acid, maleic acid and fumaric acid and anionic monomers such as anhydrides and salts of these acidic monomers. Examples of the cation constituting the salt of an acidic monomer include a lithium ion, a sodium ion, a potassium ion, an ammonium ion and an organic ammonium ion. The hydrophobic unit is a unit that does not have a hydrophilic group such as an anionic group. The hydrophobic unit can be formed, for example, through polymerization of a hydrophobic monomer not having a hydrophilic group. Specific examples of the hydrophobic monomer include monomers having an aromatic ring, such as styrene, α-methylstyrene and benzyl (meth)acrylate and (meth)acrylic ester monomers, such as methyl (meth)acrylate, butyl (meth)acrylate and 2-ethylhexyl (meth)acrylate.

A urethane resin can be produced, for example, through reaction between polyisocyanate and polyol. Furthermore, a chain extender may also be reacted. Examples of the olefin resin include polyethylene and polypropylene.

### Resin Properties

In this specification, “the resin is water-soluble” means that, when the resin is neutralized with an equivalent amount of an alkali to the acid value, the resin is present in an aqueous medium without forming such a particle whose diameter can be measured by dynamic light scattering. Whether the resin is water-soluble or not can be determined in accordance with the following method. First, a liquid containing a resin neutralized with an alkali (such as sodium hydroxide and potassium hydroxide) (resin solid content: 10% by mass) equivalent to an acid value is prepared. Next, this liquid is diluted 10-fold (on a volume basis) with pure water to prepare a sample solution.

Then, the particle size of the resin in the sample solution is measured by dynamic light scattering. If there are no particles whose particle diameter can be measured, the resin is determined to be water-soluble. This measurement is performed under conditions of SetZero: 30 seconds, the number of measurements: 3 times and the measurement time: 180 seconds. A particle size distribution measuring device may be a particle size analyzer using dynamic light scattering (for example, “UPA-EX150” (trade name) available from NIKKISO CO., LTD.).

The particle size distribution measuring device and the measurement conditions should not be limited to the above.

The acid value of the water-soluble resin is preferably 100 mgKOH/g or more to 250 mgKOH/g or less. In this specification, a value measured by a potentiometric titrator using a potassium hydroxide-methanol titration solution can be taken as the acid value of the resin. The weight average molecular weight of the water-soluble resin is preferably 3,000 or more to 15,000 or less. In this specification, the weight average molecular weight of the resin can be determined in terms of polystyrene by gel permeation chromatography (GPC).

### Wax Particle

The ink can contain a particle formed of wax (wax particle). The use of the ink containing a wax particle enables recording of an image having further improved abrasion resistance. The wax in this specification may be a composition including a component in addition to a wax or may be a wax itself. The wax particle may be dispersed by a dispersant such as a surfactant and a water-soluble resin. The waxes may be used either alone or in combination. The content (% by mass) of the wax particle contained in the ink is preferably 0.1% by mass or more to 10.0% by mass or less, more preferably 1.0% by mass or more to 5.0% by mass or less based on the total mass of the ink.

In a narrow sense of the term, a wax is an ester of a water-insoluble higher monohydric or dihydric alcohol and a fatty acid and includes animal waxes and plant waxes but does not include fats and oils. In a broad sense of the term, a wax includes a high-melting point fat, a mineral wax, a petroleum wax and blended products and modified products of various waxes. In the recording method according to the present disclosure, any wax in the broad sense of the term can be used without restriction. Waxes in the broad sense of the term can be classified into a natural wax, a synthetic wax, a blended product of these waxes (blended wax) and a modified product of these waxes (modified wax).

Examples of the natural wax include animal waxes, such as beeswax, spermaceti and wool wax (lanolin), plant waxes, such as Japan wax, carnauba wax, sugar cane wax, palm wax, candelilla wax and rice oil wax, mineral waxes, such as montan wax, petroleum waxes, such as paraffin wax, microcrystalline wax and petrolatum. Examples of the synthetic wax include a hydrocarbon wax, such as Fischer-Tropsch wax and polyolefin wax (e.g., polyethylene wax and polypropylene wax). The blended wax is a mixture of the waxes listed above. Examples of the modified wax include waxes of the above listed waxes subjected to modification processes such as oxidation, hydrogenation, alcohol modification, acrylic modification and urethane modification. The waxes may be used either alone or in combination. The wax can be at least one selected from the group consisting of microcrystalline wax, Fischer-Tropsch wax, polyolefin wax, paraffin wax and modified or blended products of these. Among them, a blended product of several types of wax can be particularly used, and a blended product of a petroleum wax and a synthetic wax can be more particularly used.

The wax that is solid at room temperature (25° C.) can be used. The melting point (° C.) of the wax is preferably 40° C. or more to 120° C. or less, more preferably 50° C. or more to 100° C. or less. The melting point of the wax can be measured in accordance with the test method described in 5.3.1 (Melting point test method) of JIS K2235: 1991 (Petroleum waxes). When a microcrystalline wax, petrolatum or a mixture of multiple types of waxes is used, the melting point can be more accurately measured in accordance with the test method described in 5.3.2. The melting point of wax is easily influenced by characteristics such as a molecular weight (the larger the molecular weight, the higher the melting point), a molecular structure (a linear chain increases a melting point, while a branching structure lowers the melting point), crystallinity (the higher the crystallinity, the higher the melting point) and density (the higher the density, the higher the melting point). The wax can have a desired melting point when these characteristics are controlled. The melting point of wax in an ink can be determined in accordance with the above test method, for example, by using wax that is separated from ink by ultracentrifugation and then washed and dried.

### Aqueous Medium

The ink is an aqueous ink containing at least water as the aqueous medium. The ink can contain water or an aqueous medium that is a mixed solvent of water and a water-soluble organic solvent. As the water, deionized water or ion-exchanged water can be used. The content (% by mass) of water contained in the ink is preferably 40.0% by mass or more to 95.0% by mass or less, more preferably 50.0% by mass or more to 90.0% by mass or less based on the total mass of the ink.

As the water-soluble organic solvent, any solvent that can be used in ink for ink jet printing, such as alcohols, (poly)alkylene glycols, glycol ethers, nitrogen-containing solvents and sulfur-containing solvents may be used. The water-soluble organic solvents may be used either alone or in combination. The content (% by mass) of the water-soluble organic solvent in the ink is preferably 2.0% by mass or more to 50.0% by mass or less, more preferably 3.0% by mass or more to 45.0% by mass or less based on the total mass of the ink. The content (% by mass) of the water-soluble organic solvent contained in the ink may be 0% by mass. In other words, the ink may contain no water-soluble organic solvent.

As described above, to improve the water abrasion resistance, in the ink, the content (% by mass) of the first water-soluble organic solvent having a vapor pressure of 3.1×10⁻⁵ kPa or less is required to be 9.0% by mass or less based on the total mass of the ink. Furthermore, the content (% by mass) of the second water-soluble organic solvent having a relative permittivity of 28.0 or more and a vapor pressure of 4.0×10⁻³ kPa or less in the ink is required to be 9.0% by mass or less based on the total mass of the ink. Preferably, the content (% by mass) of the first water-soluble organic solvent is 3.0% by mass or less based on the total mass of the ink, and the content (% by mass) of the second water-soluble organic solvent is 3.0% by mass or less based on the total mass of the ink. The content of the first water-soluble organic solvent and the content of the second water-soluble organic solvent in the ink may be 0.0% by mass. In other words, the ink may contain virtually no first and second water-soluble organic solvents. The first water-soluble organic solvent may be one that satisfies the requirements of the second water-soluble organic solvent. In other words, the first water-soluble organic solvent may have a relative permittivity of 28.0 or more and a vapor pressure of 3.1×10⁻⁵ kPa or less.

The “vapor pressure” in this specification is a value at 25° C. and 1 atm. The “relative permittivity” in this specification is a value measured at 25° C. The relative permittivity of the water-soluble organic solvent can be determined, for example, by using a dielectric constant meter (“BI-870” (trade name) available from Nihon Rufuto Co., Ltd.). The relative permittivity of the water-soluble organic solvents in Examples below were measured by the method described above.

Examples of the first water-soluble organic solvent having a vapor pressure of 3.1×10⁻⁵ kPa or less include triethanolamine (1.0×10⁻⁶), polyethylene glycol (1.0×10⁻⁶) having a number average molecular weight of 600, glycerin (3.1×10⁻⁵), 1,2,6-hexanetriol (2.8×10⁻⁶), 1-(2-hydroxyethyl)-2-pyrrolidone (2.0×10⁻⁵) and trimethylolpropane (2.1×10⁻⁵). The values in parentheses above are vapor pressures (kPa) at 25° C. Some of the first water-soluble organic solvents satisfy the definition of the second water-soluble organic solvent.

Specific examples of the second water-soluble organic solvent include glycerin (42.3/3.1×10⁻⁵), 2-methylhexane-1,3-propanediol (28.3/2.8×10⁻³), 1,4-butanediol (31.1/1.9×10⁻³), trimethylolpropane (33.7/2.1×10⁻⁵), diethylene glycol (31.7/6.0×10⁻⁴), 3-methylsulforane (29.0/9.4×10⁻⁴) and 2-pyrrolidone (28.0/3.9×10⁻³). In the above parentheses, the values on the left side are relative permittivities at 25° C. and the values on the right side are vapor pressures (kPa) at 25° C. Some of the second water-soluble organic solvents satisfy the definition of the first water-soluble organic solvent.

To further improve the water abrasion resistance of the image, the ink can further contain a third water-soluble organic solvent that has a lower vapor pressure than water. A certain degree of ink flowability is necessary for protonic diffusion, but water, which has a very high vapor pressure, tends to evaporate quickly and reduce ink flowability. Thus, it is better that the ink contains a water-soluble organic solvent that has a lower vapor pressure than water and does not inhibit the reaction, so that the resin particle can uniformly react. Here, the third water-soluble organic solvent may be one of the examples listed as the first and second water-soluble organic solvent or may be a water-soluble organic solvent having a vapor pressure of more than 4.0×10⁻³ kPa and a vapor pressure lower than that of water. The vapor pressure of water at 25° C. is 3.2 kPa. The content (% by mass) of the third water soluble organic solvent in the ink is preferably 1.0% by mass or more to 20.0% by mass or less based on the total mass of the ink.

For uniform reaction of the resin particle, among the third water-soluble organic solvents, a 1,2-alkanediol can be particularly used. The 1,2-alkanediol can function as a surfactant because the hydroxy group, which is a hydrophilic group, is concentrated at the end of the molecule. In other words, it is easy for the portion having the hydrocarbon group to solvate to the hydrophobic portion of the resin particle. This is likely to improve the flowability around the resin particle and thus makes it easier for the reaction between the resin particle and the acidic compound to proceed, further improving the water abrasion resistance. Examples of the 1,2-alkanediol include 1,2-propanediol, 1,2-butanediol, 1,2-pentanediol and 1,2-hexanediol. One or more of these can be used.

Furthermore, when the ink contains a 1,2-alkanediol, the amount (μmol/g) of the anionic group in the pigment is preferably 2.0 times or more the amount (μmol/g) of the anionic group in the resin particle to further improve the water abrasion resistance of the image. When the amount of the anionic group in the pigment is 2.0 times or more the amount of the anionic group in the resin particle, the hydrophilicity of the pigment increases, and a 1,2-alkanediol, which is easy to solvate to the hydrophobic surface as above, can solvate preferentially to the resin particle. This can further increase flowability around the resin particle. Furthermore, when a 1,2-alkanediol preferentially solvates to the resin particle, the pigment is easy to aggregate due to hydrophobic interactions. The pigment then aggregates first, and then the resin particle forms an ink layer that wraps the pigment aggregate. The pigment is likely to have a lower film strength than the resin particle, and thus the presence of the pigment between the resin particles may decrease the film strength. However, the film strength is less likely to decrease when the pigment agglomerate is wrapped by the resin particle. Furthermore, the amount of the anionic group in the pigment is preferably 3.0 times or more the amount of the anionic group in the resin particle, more preferably 4.5 times or less. The amount (μmol/g) of the anionic group in the pigment can be determined by the colloidal titration method in the same way as the amount (μmol/g) of the anionic group in the resin particle. In Examples described below, the amount of the anionic group in the pigment was measured in the same way as that in the resin particle. The pigment, which has a different density than the resin particle, can be separated by the above-described density gradient centrifugation method for the ink.

### Other Components

The ink may contain various other components as needed. Examples of the other components include various additives, such as a defoamer, a surfactant, a pH adjuster, a viscosity modifier, an antirust, a preservative, a fungicide, an oxidation inhibitor and a reduction inhibitor. However, the ink can be free from a reactant that is contained in the reaction liquid.

### Physical Properties of Ink

The ink is an aqueous ink applicable to the ink jet system. Thus, in view of reliability, the physical properties of the ink may be controlled appropriately. Specifically, the surface tension of the ink at 25° C. is preferably 20 mN/m or more to 60 mN/m or less. Furthermore, the viscosity of the ink at 25° C. is preferably 1.0 mPa·s or more to 10.0 mPa·s or less. The pH of the ink at 25° C. is preferably 7.0 or more to 9.5 or less, more preferably 8.0 or more to 9.5 or less.

### Examples

Hereinafter, the present disclosure will be described in more detail by way of examples and comparative examples, but the invention is not be limited to the examples described below. The contents of components expressed in “part(s)” or “%” are on a mass basis unless otherwise specified.

### Preparation of Cationic Resins

Table 1 indicates details of cationic resins 1 to 5 used to prepare reaction liquids.

TABLE 1
Aqueous Liquid of Cationic Resin

| | | Cationic Resin | | | |
|---|---|---|---|---|---|
| | | | | Weight | Cationic |
| | | | | Average | Resin |
| Cationic | Product Name | | Cationicity | Molecular | Content |
| Resin | (manufacturer) | Kind | (meq/g) | Weight | (%) |
| 1 | Polyquat | Poly(diallyldimethylammoniumchloride) | 6 | 9,000 | 40 |
| | 40u05NV | | | | |
| | (KATPOL | | | | |
| | Chemie) | | | | |
| 2 | PAS-2401 | Diallylmethylethyl- | 2 | 2,000 | 25 |
| | (Nittobo | ammoniumethylsulfate | | | |
| | Medical Co., | sulfur dioxide copolymer | | | |
| | Ltd.) | | | | |
| 3 | PAS-A-5 | Diallyldimethyl-ammoniumchloride | 3 | 4,000 | 40 |
| | (Nittobo | sulfur dioxide copolymer | | | |
| | Medical Co., | | | | |
| | Ltd.) | | | | |
| 4 | Catiomaster | Dimethylamine Epichlorohydrine | 7 | 9,000 | 50 |
| | PD-30 | Copolymer | | | |
| | (Yokkaichi | | | | |
| | Chemical | | | | |
| | Company | | | | |
| | Limited) | | | | |
| 5 | PAA-HCL-01 | Allylamine hydrochloride polymer | 9 | 1,600 | 33 |
| | (Nittobo | | | | |
| | Medical Co., | | | | |
| | Ltd.) | | | | |

### Preparation of Reaction Liquids

### Reaction Liquids 1 to 30

Components (%) indicated in Table 2 (Tables 2-1 to 2-5) were mixed and thoroughly stirred and then pressure-filtered through a cellulose acetate filter having a pore size of 3.0 μm (available from ADVANTEC CO., LTD.) to prepare reaction liquids. In Table 2, molecular weights (MW) and pKa values are indicated in parentheses to the right of the names of the acidic compounds (succinic acid to nitric acid). Furthermore, in Table 2, the values in parentheses after each of the polyvalent metal salts (magnesium sulfate heptahydrate to calcium lactate) indicate a molecular weight (MW) and solubility(S) (g/100 mL) in 20° C. water. Furthermore, “BYK349” in Table 2 is the trade name for a silicone surfactant (available from BYK Japan) (the same applies hereinafter).

TABLE 2-1
Composition and Properties of Reaction Liquid

| | Reaction Liquid | | | | | |
|---|---|---|---|---|---|---|
| | 1 | 2 | 3 | 4 | 5 | 6 |
| Succinic Acid (MW 118.09, pKa 4.0) | 2.0 | 2.0 | 2.0 | | | |
| Glutaric Acid (MW 132.11, pKa 4.3) | | | | 2.2 | | |
| Pyrrolidone Carboxylic Acid (MW 129.11, pKa 3.3) | | | | | 2.2 | |
| Phosphoric Acid (MW 98.00, pKa 2.1) | | | | | | 1.7 |
| Maleic Acid (MW 116.1, pKa 1.8) | | | | | | |
| Propionic Acid (MW 74.08, pKa 4.9) | | | | | | |
| Pivalic Acid (MW 102.13, pKa 5.0) | | | | | | |
| Acetic Acid (MW 60.05, pKa 4.8) | | | | | | |
| Nitric Acid (MW 63.00, pKa −1.8) | | | | | | |
| Magnesium Sulfate Heptahydrate (MW 246.47, S26.9) | 4.1 | | 4.1 | 4.1 | 4.1 | 4.1 |
| Calcium Lactate (MW 218.22, S3.1) | | | | | | |
| Magnesium Nitrate Hexahydrate (MW 256.41, 69.0) | | | | | | |
| Calcium Chloride, 2-hydrate (MW 147.01, 74.5) | | | | | | |
| Aqueous Solution of Resin 1 | | 10.0 | 10.0 | | | |
| Aqueous Solution of Resin 2 | | | | | | |
| Aqueous Solution of Resin 3 | | | | | | |
| Aqueous Solution of Resin 4 | | | | | | |
| Aqueous Solution of Resin 5 | | | | | | |
| 1,2-Butanediol | 20.0 | 20.0 | 20.0 | 20.0 | 20.0 | 20.0 |
| BYK349 | 0.3 | 0.3 | 0.3 | 0.3 | 0.3 | 0.3 |
| Ion Exchanged Water | 73.6 | 67.7 | 63.6 | 73.4 | 73.4 | 73.9 |
| Molar Concentration of Polyvalent Metal Ion | 0.0166 | 0.0000 | 0.0166 | 0.0166 | 0.0166 | 0.0166 |
| M_{M} (mol/100 g) | | | | | | |
| Molar Concentration of Acidic Compound | 0.0169 | 0.0169 | 0.0169 | 0.0167 | 0.0170 | 0.0173 |
| M_{A} (mol/100 g) | | | | | | |
| Molar ratio of M_{M}/M_{A} | 0.98 | 0.00 | 0.98 | 1.00 | 0.98 | 0.96 |
| Cationic Resin Content C (%) | 0.0 | 4.0 | 4.0 | 0.0 | 0.0 | 0.0 |
| Acidic Compound Content A (%) | 2.0 | 2.0 | 2.0 | 2.2 | 2.2 | 1.7 |
| C/A Value (times) | 0.00 | 2.00 | 2.00 | 0.00 | 0.00 | 0.00 |

TABLE 2-2
Composition and Properties of Reaction Liquid

| | Reaction Liquid | | | | | |
|---|---|---|---|---|---|---|
| | 7 | 8 | 9 | 10 | 11 | 12 |
| Succinic Acid (MW 118.09, pKa 4.0) | | | | | 2.0 | 2.0 |
| Glutaric Acid (MW 132.11, pKa 4.3) | | | | | | |
| Pyrrolidone Carboxylic Acid (MW 129.11, pKa 3.3) | | | | | | |
| Phosphoric Acid (MW 98.00, pKa 2.1) | | | | | | |
| Maleic Acid (MW 116.1, pKa 1.8) | 2.0 | | | | | |
| Propionic Acid (MW 74.08, pKa 4.9) | | 1.3 | | | | |
| Pivalic Acid (MW 102.13, pKa 5.0) | | | 1.9 | | | |
| Acetic Acid (MW 60.05, pKa 4.8) | | | | 1.0 | | |
| Nitric Acid (MW 63.00, pKa −1.8) | | | | | | |
| Magnesium Sulfate Heptahydrate (MW 246.47, S26.9) | 4.1 | 4.1 | 4.1 | 4.1 | | |
| Calcium Lactate (MW 218.22, S3.1) | | | | | | 3.7 |
| Magnesium Nitrate Hexahydrate (MW 256.41, 69.0) | | | | | | |
| Calcium Chloride, 2-hydrate (MW 147.01, 74.5) | | | | | | |
| Aqueous Solution of Resin 1 | | | | | | |
| Aqueous Solution of Resin 2 | | | | | | |
| Aqueous Solution of Resin 3 | | | | | | |
| Aqueous Solution of Resin 4 | | | | | | |
| Aqueous Solution of Resin 5 | | | | | | |
| 1,2-Butanediol | 20.0 | 20.0 | 20.0 | 20.0 | 20.0 | 20.0 |
| BYK349 | 0.3 | 0.3 | 0.3 | 0.3 | 0.3 | 0.3 |
| Ion Exchanged Water | 73.6 | 74.3 | 73.7 | 74.6 | 77.7 | 74.0 |
| Molar Concentration of Polyvalent Metal Ion | 0.0166 | 0.0166 | 0.0166 | 0.0166 | 0.0000 | 0.0170 |
| M_{M} (mol/100 g) | | | | | | |
| Molar Concentration of Acidic Compound | 0.0172 | 0.0175 | 0.0186 | 0.0167 | 0.0169 | 0.0169 |
| M_{A} (mol/100 g) | | | | | | |
| Molar ratio of M_{M}/M_{A} | 0.97 | 0.95 | 0.89 | 1.00 | 0.00 | 1.00 |
| Cationic Resin Content C (%) | 0.0 | 0.0 | 0.0 | 0.0 | 0.0 | 0.0 |
| Acidic Compound Content A (%) | 2.0 | 1.3 | 1.9 | 1.0 | 2.0 | 2.0 |
| C/A Value (times) | 0.00 | 0.00 | 0.00 | 0.00 | 0.00 | 0.00 |

TABLE 2-3
Composition and Properties of Reaction Liquid

| | Reaction Liquid | | | | | |
|---|---|---|---|---|---|---|
| | 13 | 14 | 15 | 16 | 17 | 18 |
| Succinic Acid (MW 118.09, pKa 4.0) | 2.0 | 2.0 | 2.0 | 2.0 | 0.5 | 0.5 |
| Glutaric Acid (MW 132.11, pKa 4.3) | | | | | | |
| Pyrrolidone Carboxylic Acid (MW 129.11, pKa 3.3) | | | | | | |
| Phosphoric Acid (MW 98.00, pKa 2.1) | | | | | | |
| Maleic Acid (MW 116.1, pKa 1.8) | | | | | | |
| Propionic Acid (MW 74.08, pKa 4.9) | | | | | | |
| Pivalic Acid (MW 102.13, pKa 5.0) | | | | | | |
| Acetic Acid (MW 60.05, pKa 4.8) | | | | | | |
| Nitric Acid (MW 63.00, pKa −1.8) | | | | | | |
| Magnesium Sulfate Heptahydrate (MW 246.47, S26.9) | | | 2.4 | 2.5 | 10.4 | 10.5 |
| Calcium Lactate (MW 218.22, S3.1) | | | | | | |
| Magnesium Nitrate Hexahydrate (MW 256.41, 69.0) | 4.3 | | | | | |
| Calcium Chloride, 2-hydrate (MW 147.01, 74.5) | | 2.5 | | | | |
| Aqueous Solution of Resin 1 | | | | | | |
| Aqueous Solution of Resin 2 | | | | | | |
| Aqueous Solution of Resin 3 | | | | | | |
| Aqueous Solution of Resin 4 | | | | | | |
| Aqueous Solution of Resin 5 | | | | | | |
| 1,2-Butanediol | 20.0 | 20.0 | 20.0 | 20.0 | 20.0 | 20.0 |
| BYK349 | 0.3 | 0.3 | 0.3 | 0.3 | 0.3 | 0.3 |
| Ion Exchanged Water | 73.4 | 75.2 | 75.3 | 75.2 | 68.8 | 68.7 |
| Molar Concentration of Polyvalent Metal Ion | 0.0168 | 0.0170 | 0.0097 | 0.0101 | 0.0422 | 0.0426 |
| M_{M} (mol/100 g) | | | | | | |
| Molar Concentration of Acidic Compound | 0.0169 | 0.0169 | 0.0169 | 0.0169 | 0.0042 | 0.0042 |
| M_{A} (mol/100 g) | | | | | | |
| Molar ratio of M_{M}/M_{A} | 0.99 | 1.00 | 0.57 | 0.60 | 9.97 | 10.06 |
| Cationic Resin Content C (%) | 0.0 | 0.0 | 0.0 | 0.0 | 0.0 | 0.0 |
| Acidic Compound Content A (%) | 2.0 | 2.0 | 2.0 | 2.0 | 0.5 | 0.5 |
| C/A Value (times) | 0.00 | 0.00 | 0.00 | 0.00 | 0.00 | 0.00 |

TABLE 2-4
Composition and Properties of Reaction Liquid

| | Reaction Liquid | | | | | |
|---|---|---|---|---|---|---|
| | 19 | 20 | 21 | 22 | 23 | 24 |
| Succinic Acid (MW 118.09, pKa 4.0) | 2.0 | 2.0 | 0.5 | 0.5 | 2.0 | 2.0 |
| Glutaric Acid (MW 132.11, pKa 4.3) | | | | | | |
| Pyrrolidone Carboxylic Acid (MW 129.11, pKa 3.3) | | | | | | |
| Phosphoric Acid (MW 98.00, pKa 2.1) | | | | | | |
| Maleic Acid (MW 116.1, pKa 1.8) | | | | | | |
| Propionic Acid (MW 74.08, pKa 4.9) | | | | | | |
| Pivalic Acid (MW 102.13, pKa 5.0) | | | | | | |
| Acetic Acid (MW 60.05, pKa 4.8) | | | | | | |
| Nitric Acid (MW 63.00, pKa −1.8) | | | | | | |
| Magnesium Sulfate Heptahydrate (MW 246.47, S26.9) | | | | | | |
| Calcium Lactate (MW 218.22, S3.1) | | | | | | |
| Magnesium Nitrate Hexahydrate (MW 256.41, 69.0) | | | | | | |
| Calcium Chloride, 2-hydrate (MW 147.01, 74.5) | | | | | | |
| Aqueous Solution of Resin 1 | | | | | 6.1 | 6.3 |
| Aqueous Solution of Resin 2 | 10.0 | | | | | |
| Aqueous Solution of Resin 3 | | 6.25 | | | | |
| Aqueous Solution of Resin 4 | | | 5.0 | | | |
| Aqueous Solution of Resin 5 | | | | 7.5 | | |
| 1,2-Butanediol | 20.0 | 20.0 | 20.0 | 20.0 | 20.0 | 20.0 |
| BYK349 | 0.3 | 0.3 | 0.3 | 0.3 | 0.3 | 0.3 |
| Ion Exchanged Water | 67.7 | 71.5 | 74.2 | 71.7 | 71.6 | 71.4 |
| Molar Concentration of Polyvalent Metal Ion | 0.0000 | 0.0000 | 0.0000 | 0.0000 | 0.0000 | 0.0000 |
| M_{M} (mol/100 g) | | | | | | |
| Molar Concentration of Acidic Compound | 0.0169 | 0.0169 | 0.0042 | 0.0042 | 0.0169 | 0.0169 |
| M_{A} (mol/100 g) | | | | | | |
| Molar ratio of M_{M}/M_{A} | 0.00 | 0.00 | 0.00 | 0.00 | 0.00 | 0.00 |
| Cationic Resin Content C (%) | 2.5 | 2.5 | 2.5 | 2.5 | 2.4 | 2.5 |
| Acidic Compound Content A (%) | 2.0 | 2.0 | 0.5 | 0.5 | 2.0 | 2.0 |
| C/A Value (times) | 1.25 | 1.25 | 5.00 | 5.00 | 1.20 | 1.25 |

TABLE 2-5
Composition and Properties of Reaction Liquid

| | Reaction Liquid | | | | | |
|---|---|---|---|---|---|---|
| | 25 | 26 | 27 | 28 | 29 | 30 |
| Succinic Acid (MW 118.09, pKa 4.0) | 0.5 | 0.5 | | | | |
| Glutaric Acid (MW 132.11, pKa 4.3) | | | | | | |
| Pyrrolidone Carboxylic Acid (MW 129.11, pKa 3.3) | | | | | | |
| Phosphoric Acid (MW 98.00, pKa 2.1) | | | | | | |
| Maleic Acid (MW 116.1, pKa 1.8) | | | | | | |
| Propionic Acid (MW 74.08, pKa 4.9) | | | | | | |
| Pivalic Acid (MW 102.13, pKa 5.0) | | | | | | |
| Acetic Acid (MW 60.05, pKa 4.8) | | | | | | |
| Nitric Acid (MW 63.00, pKa −1.8) | | | 1.0 | | | |
| Magnesium Sulfate Heptahydrate (MW 246.47, S26.9) | | | | | 4.1 | |
| Calcium Lactate (MW 218.22, S3.1) | | | | | | |
| Magnesium Nitrate Hexahydrate (MW 256.41, 69.0) | | | | | | |
| Calcium Chloride, 2-hydrate (MW 147.01, 74.5) | | | | | | |
| Aqueous Solution of Resin 1 | 15.7 | 15.9 | | | | 10.0 |
| Aqueous Solution of Resin 2 | | | | | | |
| Aqueous Solution of Resin 3 | | | | | | |
| Aqueous Solution of Resin 4 | | | | | | |
| Aqueous Solution of Resin 5 | | | | | | |
| 1,2-Butanediol | 20.0 | 20.0 | 20.0 | 20.0 | 20.0 | 20.0 |
| BYK349 | 0.3 | 0.3 | 0.3 | 0.3 | 0.3 | 0.3 |
| Ion Exchanged Water | 63.5 | 63.3 | 78.7 | 79.7 | 75.6 | 69.7 |
| Molar Concentration of Polyvalent Metal Ion | 0.0000 | 0.0000 | 0.0000 | 0.0000 | 0.0166 | 0.0000 |
| M_{M} (mol/100 g) | | | | | | |
| Molar Concentration of Acidic Compound | 0.0042 | 0.0042 | 0.0159 | 0.0000 | 0.0000 | 0.0000 |
| M_{A} (mol/100 g) | | | | | | |
| Molar ratio of M_{M}/M_{A} | 0.00 | 0.00 | 0.00 | — | — | — |
| Cationic Resin Content C (%) | 6.3 | 6.4 | 0.0 | 0.0 | 0.0 | 4.0 |
| Acidic Compound Content A (%) | 0.5 | 0.5 | 1.0 | 0.0 | 0.0 | 0.0 |
| C/A Value (times) | 12.60 | 12.80 | 0.00 | — | — | — |

### Reaction Liquid 31

Components (%) indicated below were mixed and thoroughly stirred and then pressure-filtered through a cellulose acetate filter having a pore size of 3.0 μm (available from ADVANTEC CO., LTD.) to prepare a reaction liquid 31.
Sodium sulfate heptahydrate: 20.0%
3-Methyl-1,3-butanediol: 5.0%
Glycerin: 20.0%
BYK349: 0.3%
Ion exchanged water: 54.7%
Reaction Liquid 32

Components (%) indicated below were mixed and thoroughly stirred and then pressure-filtered through a cellulose acetate filter having a pore size of 3.0 μm (available from ADVANTEC CO., LTD.) to prepare a reaction liquid 32.
Acetic acid: 3.0%
Dipropylene glycol dimethyl ether: 15.0%
2-pyrrolidone: 10.0%
1,2-hexanediol: 1.0%
Defoamer (“SURFYNOL DF110D” (trade name) available from Nissin Chemical Industry Co., Ltd.): 0.1%
Surfactant (“BYK-3455” (trade name) available from BYK): 0.8%
Ion exchanged water: 70.1%

### Preparation of Pigment Dispersion Liquid

A styrene-ethyl acrylate-acrylic acid copolymer (resin 1) having an acid value of 150 mgKOH/g and a weight average molecular weight of 8,000 was prepared. After 20.0 parts of the resin 1 was neutralized with potassium hydroxide equimolar to the acid value, an appropriate content of ion-exchanged water was added to prepare an aqueous solution of the resin 1 having the resin content (solid content) of 20.0%. Pigments of the kinds indicated in Table 3, the aqueous solution of the resin 1 and ion-exchanged water were mixed to produce mixtures. The produced mixture and 200 parts of zirconia beads having a diameter of 0.3 mm were placed in a batch-type vertical sand mill (available from IMEX Co., Ltd.) and dispersed for 5 hours while being cooled with water. After coarse particles were removed by centrifugal separation, the mixtures were pressure-filtered through a cellulose acetate filter having a pore size of 3.0 μm (available from ADVANTEC CO., LTD.) to prepare pigment dispersion liquids. The lower section of Table 3 indicates properties of each pigment dispersion liquid.

TABLE 3
Composition and Properties of Pigment Dispersion Liquid

| | Pigment Dispersion Liquid | | | | | | | | |
|---|---|---|---|---|---|---|---|---|---|
| | 1 | 2 | 3 | 4 | 5 | 6 | 7 | 8 | 9 |
| C.I. Pigment Blue 15:3 | 10.0 | | | | 10.0 | 10.0 | 10.0 | 20.0 | 20.0 |
| Carbon Black | | 10.0 | | | | | | | |
| C.I. Pigment Red 122 | | | 10.0 | | | | | | |
| C.I. Pigment Yellow 74 | | | | 10.0 | | | | | |
| Aqueous Solution of Resin 1 | 15.0 | 15.0 | 15.0 | 15.0 | 47.0 | 7.5 | 7.0 | 30.0 | 50.0 |
| Diethylene Glycol | | | | | | | | | 10.0 |
| Ion Exchanged Water | 75.0 | 75.0 | 75.0 | 75.0 | 43.0 | 82.5 | 83.0 | 50.0 | 20.0 |
| Pigment Content P (%) | 10.0 | 10.0 | 10.0 | 10.0 | 10.0 | 10.0 | 10.0 | 20.0 | 20.0 |
| Resin Dispersant Content (%) | 3.0 | 3.0 | 3.0 | 3.0 | 9.4 | 1.5 | 1.4 | 6.0 | 10.0 |
| R/P Value (times) | 0.30 | 0.30 | 0.30 | 0.30 | 0.94 | 0.15 | 0.14 | 0.30 | 0.50 |
| Amount of Anionic Group Ep (μmol/g) | 398 | 398 | 398 | 398 | 1250 | 190 | 205 | 398 | 663 |

### Synthesis of Resin Particle

In a four-necked flask equipped with a stirrer, a reflux cooling device and a nitrogen gas inlet tube, 190.0 parts of ion-exchanged water and 0.2 parts of potassium persulfate were added and mixed. In addition, monomers indicated in Table 4 and 0.3 parts of a reactive surfactant were mixed to prepare an emulsion. In Table 4, “Blemmer PME-1000” is the trade name for methoxy polyethylene glycol monomethacrylate (number of ethylene oxide units: about 23) (available from NOF CORPORATION). As a reactive surfactant, a nonionic surfactant, “ADEKA REASOAP ER20” (trade name) (available from ADEKA CORPORATION, number of ethylene oxide units: 20) was used. Under a nitrogen atmosphere, the prepared emulsion was dropped into the above four-necked flask over one hour and then subjected to polymerization reaction for two hours at 80° C. while being stirred. After the emulsion was cooled to 25° C., ion-exchanged water and an aqueous solution containing potassium hydroxide equimolar to the anionic group in the resin particle were added to prepare aqueous dispersion liquids of the resin particles having a resin particle content (solid content) of 25.0%. In the lower section of Table 4, the properties of the resin particle such as the glass transition temperature T_{G} (° C.) measured by DSC, the amount (μmol/g) of the anionic group Ee and the value of pKa₁ are indicated.

TABLE 4-1
Synthesis Condition and Properties of Resin Particle

| | Resin Particle | | | | | | | |
|---|---|---|---|---|---|---|---|---|
| | 1 | 2 | 3 | 4 | 5 | 6 | 7 | 8 |
| Ethyl Methacrylate | 90.0 | 90.0 | 90.0 | 91.0 | 90.0 | 90.0 | 75.0 | 90.0 |
| n-Butyl Acrylate | 3.0 | 3.0 | 3.0 | 3.0 | 3.0 | 3.0 | 3.0 | 3.0 |
| Styrene | | | | | | | | |
| Acrylic Acid | 0.7 | 0.5 | 0.6 | 0.7 | 1.8 | 1.9 | 4.2 | |
| Methacrylic Acid | | | | | | | | 0.8 |
| p-Styrenesulfonic Acid Sodium Salt | | | | | | | | |
| BLEMMER PME-1000 | | | | | | | | |
| Glass Transition Temperature T_{G} (° C.) | 60 | 60 | 60 | 60 | 60 | 60 | 60 | 60 |
| Amount of Anionic Group Ee (μmol/g) | 100 | 75 | 90 | 95 | 270 | 275 | 600 | 100 |
| pKa₁ | 4.4 | 4.4 | 4.4 | 4.4 | 4.4 | 4.4 | 4.4 | 4.7 |

TABLE 4-2
Synthesis Condition and Properties of Resin Particle

| | Resin Particle | | | | | | |
|---|---|---|---|---|---|---|---|
| | 9 | 10 | 11 | 12 | 13 | 14 | 15 |
| Ethyl Methacrylate | 70.0 | 73.0 | 30.0 | 70.0 | 80.0 | 90.0 | 90.0 |
| n-Butyl Acrylate | 23.0 | 20.0 | 3.0 | 23.0 | | 3.0 | 3.0 |
| Styrene | | | 60.0 | | | | |
| Acrylic Acid | 0.7 | 0.7 | 0.7 | | | 0.4 | 4.5 |
| Methacrylic Acid | | | | | | | |
| p-Styrenesulfonic Acid Sodium Salt | | | | 2.0 | | | |
| BLEMMER PME-1000 | | | | | 1.6 | | |
| Glass Transition Temperature T_{G} (° C.) | 25 | 30 | 80 | 25 | 60 | 60 | 60 |
| Amount of Anionic Group Ee (μmol/g) | 100 | 100 | 100 | 100 | 0 | 65 | 640 |
| pKa₁ | 4.4 | 4.4 | 4.4 | −2.5 | — | 4.4 | 4.4 |

### Preparation of Ink

### Inks 1 to 50

Components (%) indicated in the middle section of Table 5 (Tables 5-1 to 5-6) were mixed and thoroughly stirred and then pressure-filtered through a cellulose acetate filter having a pore size of 3.0 μm (available from ADVANTEC CO., LTD.) to prepare inks. As the pigment dispersion liquids and aqueous dispersion liquids of the resin particles, those indicated by numbers in the upper section of Table 5 were used. In Table 5, in the parentheses after the water-soluble organic solvents, the values on the left side are the relative permittivities at 25° C., and the values on the right side are the vapor pressures at 25° C. (kPa).

The lower section of Table 5 indicates the first water-soluble organic solvent (abbreviated as “first solvent”) content (%) and the second water-soluble organic solvent (abbreviated as “second solvent”) content of the ink and the pigment content (%) and the resin particle content (%) of the ink. The section further indicates the amounts of the anionic group in the pigment and in the resin particle (μmol/g), as well as the amount of the anionic group in the pigment/the amount of the anionic group in the resin particle (times). The amounts of the anionic group were measured by the following method. Specifically, the ink was subjected to gradient centrifugation at 50,000 rpm for 5 hours at 4° C. so that the pigment dispersion liquid as the lower layer and the resin particle as the upper layer were taken out, and the precipitates generated by adding acid were dried. Then, the amount of the anionic group was measured by colloid titration using the above potential difference.

TABLE 5-1
Composition and Properties of Ink

| | Ink | | | | | | | |
|---|---|---|---|---|---|---|---|---|
| | 1 | 2 | 3 | 4 | 5 | 6 | 7 | 8 |
| Kind of Pigment Dispersion Liquid (No.) | 1 | 2 | 3 | 4 | 1 | 1 | 1 | 1 |
| Kind of Resin Particle (No.) | 1 | 1 | 1 | 1 | 1 | 1 | 1 | 1 |
| Pigment Dispersion Liquid | 15.0 | 15.0 | 15.0 | 15.0 | 15.0 | 15.0 | 15.0 | 15.0 |
| Aqueous Dispersion Liquid of Resin Particle | 30.0 | 30.0 | 30.0 | 30.0 | 30.0 | 30.0 | 30.0 | 30.0 |
| 1,2-Butanediol (22.2/2.0 × 10⁻³) | 15.0 | 15.0 | 15.0 | 15.0 | 5.0 | 5.0 | 5.0 | 5.0 |
| Triethylene Glycol (22.7/3.3 × 10⁻⁴) | | | | | 10.0 | | | |
| Glycerine (42.3/1.0 × 10⁻⁵) | | | | | | | | |
| 1,2-Hexanediol (14.8/2.6 × 10⁻³) | | | | | | 10.0 | | |
| Propylene Glycol (28.8/1.1 × 10⁻²) | | | | | | | 10.0 | |
| Diethylene Glycol Monobutyl Ether (11.0/1.7 × 10⁻³) | | | | | | | | 10.0 |
| Ethylene Glycol (40.4/1.2 × 10⁻²) | | | | | | | | |
| 2-Methyl Hexane-1,3-propanediol (28.3/2.8 × 10⁻³) | | | | | | | | |
| 1,4-Butanediol (31.1/1.9 × 10⁻³) | | | | | | | | |
| 1,3-Butanediol (30.0/7.2 × 10⁻³) | | | | | | | | |
| Trimethylolpropane (33.7/2.1 × 10⁻⁵) | | | | | | | | |
| diethylene Glycol (31.7/6.3 × 10⁻⁴) | | | | | | | | |
| 2-Pyrrolidone (28.0/1.3 × 10⁻³) | | | | | | | | |
| ethanol (23.8/1.1 × 10) | | | | | | | | |
| BYK349 | 0.5 | 0.5 | 0.5 | 0.5 | 0.5 | 0.5 | 0.5 | 0.5 |
| Ion Exchanged Water | 39.5 | 39.5 | 39.5 | 39.5 | 39.5 | 39.5 | 39.5 | 39.5 |
| Pigment Content (P) (%) | 1.5 | 1.5 | 1.5 | 1.5 | 1.5 | 1.5 | 1.5 | 1.5 |
| Resin Particle Content (E) (%) | 7.5 | 7.5 | 7.5 | 7.5 | 7.5 | 7.5 | 7.5 | 7.5 |
| E/P Value (times) | 5.0 | 5.0 | 5.0 | 5.0 | 5.0 | 5.0 | 5.0 | 5.0 |
| First Solvent Content (%) | 0.0 | 0.0 | 0.0 | 0.0 | 0.0 | 0.0 | 0.0 | 0.0 |
| Second Solvent Content (%) | 0.0 | 0.0 | 0.0 | 0.0 | 0.0 | 0.0 | 0.0 | 0.0 |
| Amount of Anionic Group in Pigment Ep (μmol/g) | 398 | 398 | 398 | 398 | 398 | 398 | 398 | 398 |
| Amount of Anionic Group in Resin Particle Ee (μmol/g) | 100 | 100 | 100 | 100 | 100 | 100 | 100 | 100 |
| Ep/Ee Value (times) | 4.0 | 4.0 | 4.0 | 4.0 | 4.0 | 4.0 | 4.0 | 4.0 |

TABLE 5-2
Composition and Properties of Ink

| | Ink | | | | | | | |
|---|---|---|---|---|---|---|---|---|
| | 9 | 10 | 11 | 12 | 13 | 14 | 15 | 16 |
| Kind of Pigment Dispersion Liquid (No.) | 1 | 1 | 5 | 1 | 1 | 1 | 1 | 1 |
| Kind of Resin Particle (No.) | 1 | 2 | 7 | 1 | 1 | 1 | 1 | 1 |
| Pigment Dispersion Liquid | 15.0 | 15.0 | 15.0 | 15.0 | 1.5 | 15.0 | 15.0 | 15.0 |
| Aqueous Dispersion Liquid of Resin Particle | 30.0 | 30.0 | 30.0 | 9.0 | 24.0 | 30.0 | 30.0 | 30.0 |
| 1,2-Butanediol (22.2/2.0 × 10⁻³) | 5.0 | 15.0 | 15.0 | 15.0 | 15.0 | 6.0 | 6.0 | 6.0 |
| Triethylene Glycol (22.7/3.3 × 10⁻⁴) | | | | | | | 9.0 | |
| Glycerine (42.3/1.0 × 10⁻⁵) | | | | | | | | 9.0 |
| 1,2-Hexanediol (14.8/2.6 × 10⁻³) | | | | | | | | |
| Propylene Glycol (28.8/1.1 × 10⁻²) | | | | | | | | |
| Diethylene Glycol Monobutyl Ether (11.0/1.7 × 10⁻³) | | | | | | | | |
| Ethylene Glycol (40.4/1.2 × 10⁻²) | 10.0 | | | | | | | |
| 2-Methyl Hexane-1,3-propanediol (28.3/2.8 × 10⁻³) | | | | | | | | |
| 1,4-Butanediol (31.1/1.9 × 10⁻³) | | | | | | 9.0 | 9.0 | |
| 1,3-Butanediol (30.0/7.2 × 10⁻³) | | | | | | | | |
| Trimethylolpropane (33.7/2.1 × 10⁻⁵) | | | | | | | | |
| Diethylene Glycol (31.7/6.3 × 10⁻⁴) | | | | | | | | |
| 2-Pyrrolidone (28.0/1.3 × 10⁻³) | | | | | | | | |
| Ethanol (23.8/1.1 × 10) | | | | | | | | |
| BYK349 | 0.5 | 0.5 | 0.5 | 0.5 | 0.5 | 0.5 | 0.5 | 0.5 |
| Ion Exchanged Water | 39.5 | 39.5 | 39.5 | 60.5 | 59.0 | 39.5 | 30.5 | 39.5 |
| Pigment Content (P) (%) | 1.5 | 1.5 | 1.5 | 1.5 | 0.2 | 1.5 | 1.5 | 1.5 |
| Resin Particle Content (E) (%) | 7.5 | 7.5 | 7.5 | 2.3 | 6.0 | 7.5 | 7.5 | 7.5 |
| E/P Value (times) | 5.0 | 5.0 | 5.0 | 1.5 | 40.0 | 5.0 | 5.0 | 5.0 |
| First Solvent Content (%) | 0.0 | 0.0 | 0.0 | 0.0 | 0.0 | 0.0 | 0.0 | 9.0 |
| Second Solvent Content (%) | 0.0 | 0.0 | 0.0 | 0.0 | 0.0 | 9.0 | 9.0 | 9.0 |
| Amount of Anionic Group in Pigment Ep (μmol/g) | 398 | 398 | 1250 | 398 | 398 | 398 | 398 | 398 |
| Amount of Anionic Group in Resin Particle Ee (μmol/g) | 100 | 75 | 600 | 100 | 100 | 100 | 100 | 100 |
| Ep/Ee Value (times) | 4.0 | 5.3 | 2.1 | 4.0 | 4.0 | 4.0 | 4.0 | 4.0 |

TABLE 5-3
Composition and Properties of Ink

| | Ink | | | | | | | |
|---|---|---|---|---|---|---|---|---|
| | 17 | 18 | 19 | 20 | 21 | 22 | 23 | 24 |
| Kind of Pigment Dispersion Liquid (No.) | 1 | 1 | 1 | 1 | 1 | 1 | 5 | 5 |
| Kind of Resin Particle (No.) | 1 | 1 | 1 | 1 | 3 | 4 | 5 | 6 |
| Pigment Dispersion Liquid | 15.0 | 15.0 | 15.0 | 15.0 | 15.0 | 15.0 | 15.0 | 15.0 |
| Aqueous Dispersion Liquid of Resin Particle | 30.0 | 30.0 | 30.0 | 30.0 | 30.0 | 30.0 | 30.0 | 30.0 |
| 1,2-Butanediol (22.2/2.0 × 10⁻³) | 5.0 | | | | 15.0 | 15.0 | 15.0 | 15.0 |
| Triethylene Glycol (22.7/3.3 × 10⁻⁴) | | | | | | | | |
| Glycerine (42.3/1.0 × 10⁻⁵) | | | | | | | | |
| 1,2-Hexanediol (14.8/2.6 × 10⁻³) | | | | | | | | |
| Propylene Glycol (28.8/1.1 × 10⁻²) | | | | | | | | |
| Diethylene Glycol Monobutyl Ether (11.0/1.7 × 10⁻³) | | | | | | | | |
| Ethylene Glycol (40.4/1.2 × 10⁻²) | | | | | | | | |
| 2-Methyl Hexane-1,3-propanediol (28.3/2.8 × 10⁻³) | 9.0 | | | | | | | |
| 1,4-Butanediol (31.1/1.9 × 10⁻³) | | 9.0 | | | | | | |
| 1,3-Butanediol (30.0/7.2 × 10⁻³) | | | | | | | | |
| Trimethylolpropane (33.7/2.1 × 10⁻⁵) | | | | | | | | |
| Diethylene Glycol (31.7/6.3 × 10⁻⁴) | | | 9.0 | | | | | |
| 2-Pyrrolidone (28.0/1.3 × 10⁻³) | | | | 9.0 | | | | |
| Ethanol (23.8/1.1 × 10) | | | | | | | | |
| BYK349 | 0.5 | 0.5 | 0.5 | 0.5 | 0.5 | 0.5 | 0.5 | 0.5 |
| Ion Exchanged Water | 40.5 | 45.5 | 45.5 | 45.5 | 39.5 | 39.5 | 39.5 | 39.5 |
| Pigment Content (P) (%) | 1.5 | 1.5 | 1.5 | 1.5 | 1.5 | 1.5 | 1.5 | 1.5 |
| Resin Particle Content (E) (%) | 7.5 | 7.5 | 7.5 | 7.5 | 7.5 | 7.5 | 7.5 | 7.5 |
| E/P Value (times) | 5.0 | 5.0 | 5.0 | 5.0 | 5.0 | 5.0 | 5.0 | 5.0 |
| First Solvent Content (%) | 0.0 | 0.0 | 0.0 | 0.0 | 0.0 | 0.0 | 0.0 | 0.0 |
| Second Solvent Content (%) | 9.0 | 9.0 | 9.0 | 9.0 | 0.0 | 0.0 | 0.0 | 0.0 |
| Amount of Anionic Group in Pigment Ep (μmol/g) | 398 | 398 | 398 | 398 | 398 | 398 | 1250 | 1250 |
| Amount of Anionic Group in Resin Particle Ee (μmol/g) | 100 | 100 | 100 | 100 | 90 | 95 | 270 | 275 |
| Ep/Ee Value (times) | 4.0 | 4.0 | 4.0 | 4.0 | 4.4 | 4.2 | 4.6 | 4.5 |

TABLE 5-4
Composition and Properties of Ink

| | Ink | | | | | | | |
|---|---|---|---|---|---|---|---|---|
| | 25 | 26 | 27 | 28 | 29 | 30 | 31 | 32 |
| Kind of Pigment Dispersion Liquid (No.) | 1 | 1 | 1 | 1 | 1 | 1 | 1 | 1 |
| Kind of Resin Particle (No.) | 1 | 1 | 1 | 1 | 8 | 9 | 10 | 11 |
| Pigment Dispersion Liquid | 15.0 | 15.0 | 15.0 | 15.0 | 15.0 | 15.0 | 15.0 | 15.0 |
| Aqueous Dispersion Liquid of Resin Particle | 30.0 | 30.0 | 30.0 | 30.0 | 30.0 | 30.0 | 30.0 | 30.0 |
| 1,2-Butanediol (22.2/2.0 × 10⁻³) | 15.0 | 15.0 | 15.0 | 15.0 | 15.0 | 15.0 | 15.0 | 15.0 |
| Triethylene Glycol (22.7/3.3 × 10⁻⁴) | | | | | | | | |
| Glycerine (42.3/1.0 × 10⁻⁵) | 3.0 | 4.0 | | | | | | |
| 1,2-Hexanediol (14.8/2.6 × 10⁻³) | | | | | | | | |
| Propylene Glycol (28.8/1.1 × 10⁻²) | | | | | | | | |
| Diethylene Glycol Monobutyl Ether (11.0/1.7 × 10⁻³) | | | | | | | | |
| Ethylene Glycol (40.4/1.2 × 10⁻²) | | | | | | | | |
| 2-Methyl Hexane-1,3-propanediol (28.3/2.8 × 10⁻³) | | | | | | | | |
| 1,4-Butanediol (31.1/1.9 × 10⁻³) | | | 3.0 | 4.0 | | | | |
| 1,3-Butanediol (30.0/7.2 × 10⁻³) | | | | | | | | |
| Trimethylolpropane (33.7/2.1 × 10⁻⁵) | | | | | | | | |
| Diethylene Glycol (31.7/6.3 × 10⁻⁴) | | | | | | | | |
| 2-Pyrrolidone (28.0/1.3 × 10⁻³) | | | | | | | | |
| Ethanol (23.8/1.1 × 10) | | | | | | | | |
| BYK349 | 0.5 | 0.5 | 0.5 | 0.5 | 0.5 | 0.5 | 0.5 | 0.5 |
| Ion Exchanged Water | 36.5 | 35.5 | 36.5 | 35.5 | 39.5 | 39.5 | 39.5 | 39.5 |
| Pigment Content (P) (%) | 1.5 | 1.5 | 1.5 | 1.5 | 1.5 | 1.5 | 1.5 | 1.5 |
| Resin Particle Content (E) (%) | 7.5 | 7.5 | 7.5 | 7.5 | 7.5 | 7.5 | 7.5 | 7.5 |
| E/P Value (times) | 5.0 | 5.0 | 5.0 | 5.0 | 5.0 | 5.0 | 5.0 | 5.0 |
| First Solvent Content (%) | 0.0 | 0.0 | 0.0 | 0.0 | 0.0 | 0.0 | 0.0 | 0.0 |
| Second Solvent Content (%) | 3.0 | 4.0 | 3.0 | 4.0 | 0.0 | 0.0 | 0.0 | 0.0 |
| Amount of Anionic Group in Pigment Ep (μmol/g) | 398 | 398 | 398 | 398 | 398 | 398 | 398 | 398 |
| Amount of Anionic Group in Resin Particle Ee (μmol/g) | 100 | 100 | 100 | 100 | 100 | 100 | 100 | 100 |
| Ep/Ee Value (times) | 4.0 | 4.0 | 4.0 | 4.0 | 4.0 | 4.0 | 4.0 | 4.0 |

TABLE 5-5
Composition and Properties of Ink

| | Ink | | | | | | | |
|---|---|---|---|---|---|---|---|---|
| | 33 | 34 | 35 | 36 | 37 | 38 | 39 | 40 |
| Kind of Pigment Dispersion Liquid (No.) | 1 | 1 | 1 | 6 | 7 | 6 | 1 | 1 |
| Kind of Resin Particle (No.) | 1 | 1 | 1 | 1 | 1 | 12 | — | 13 |
| Pigment Dispersion Liquid | 15.0 | 15.0 | 15.0 | 15.0 | 15.0 | 15.0 | 15.0 | 15.0 |
| Aqueous Dispersion Liquid of Resin Particle | 30.0 | 30.0 | 30.0 | 30.0 | 30.0 | 13.0 | | 30.0 |
| 1,2-Butanediol (22.2/2.0 × 10⁻³) | | | | 15.0 | 15.0 | | 15.0 | 15.0 |
| Triethylene Glycol (22.7/3.3 × 10⁻⁴) | | | | | | | | |
| Glycerine (42.3/1.0 × 10⁻⁵) | | | | | | | | |
| 1,2-Hexanediol (14.8/2.6 × 10⁻³) | | | | | | | | |
| Propylene Glycol (28.8/1.1 × 10⁻²) | | | | | | | | |
| Diethylene Glycol Monobutyl Ether (11.0/1.7 × 10⁻³) | | | | | | | | |
| Ethylene Glycol (40.4/1.2 × 10⁻²) | | | | | | | | |
| 2-Methyl Hexane-1,3-propanediol (28.3/2.8 × 10⁻³) | | | | | | | | |
| 1,4-Butanediol (31.1/1.9 × 10⁻³) | | | | | | | | |
| 1,3-Butanediol (30.0/7.2 × 10⁻³) | | | 15.0 | | | | | |
| Trimethylolpropane (33.7/2.1 × 10⁻⁵) | | | | | | | | |
| Diethylene Glycol (31.7/6.3 × 10⁻⁴) | | | | | | | | |
| 2-Pyrrolidone (28.0/1.3 × 10⁻³) | | | | | | | | |
| Ethanol (23.8/1.1 × 10) | | 15.0 | | | | | | |
| BYK349 | 0.5 | 0.5 | 0.5 | 0.5 | 0.5 | 0.5 | 0.5 | 0.5 |
| Ion Exchanged Water | 54.5 | 39.5 | 39.5 | 39.5 | 39.5 | 71.5 | 69.5 | 39.5 |
| Pigment Content (P) (%) | 1.5 | 1.5 | 1.5 | 1.5 | 1.5 | 1.5 | 1.5 | 1.5 |
| Resin Particle Content (E) (%) | 7.5 | 7.5 | 7.5 | 7.5 | 7.5 | 3.3 | 0.0 | 7.5 |
| E/P Value (times) | 5.0 | 5.0 | 5.0 | 5.0 | 5.0 | 2.2 | 0.0 | 5.0 |
| First Solvent Content (%) | 0.0 | 0.0 | 0.0 | 0.0 | 0.0 | 0.0 | 0.0 | 0.0 |
| Second Solvent Content (%) | 0.0 | 0.0 | 0.0 | 0.0 | 0.0 | 0.0 | 0.0 | 0.0 |
| Amount of Anionic Group in Pigment Ep (μmol/g) | 398 | 398 | 398 | 190 | 205 | 190 | 398 | 398 |
| Amount of Anionic Group in Resin Particle Ee (μmol/g) | 100 | 100 | 100 | 100 | 100 | 100 | — | 0 |
| Ep/Ee Value (times) | 4.0 | 4.0 | 4.0 | 1.9 | 2.1 | 1.9 | — | — |

TABLE 5-6
Composition and Properties of Ink

| | Ink | | | | | | | | |
|---|---|---|---|---|---|---|---|---|---|
| | 41 | 42 | 43 | 44 | 45 | 46 | 47 | 48 | 49 |
| Kind of Pigment Dispersion Liquid (No.) | 1 | 1 | 1 | 1 | 1 | 1 | 1 | 1 | 1 |
| Kind of Resin Particle (No.) | 14 | 15 | 1 | 1 | 1 | 1 | 1 | 1 | 1 |
| Pigment Dispersion Liquid | 15.0 | 15.0 | 15.0 | 15.0 | 15.0 | 15.0 | 15.0 | 15.0 | 15.0 |
| Aqueous Dispersion Liquid of Resin Particle | 30.0 | 30.0 | 8.4 | 30.0 | 30.0 | 30.0 | 30.0 | 30.0 | 30.0 |
| 1,2-Butanediol (22.2/2.0 × 10⁻³) | 15.0 | 15.0 | 15.0 | | | | | | |
| Triethylene Glycol (22.7/3.3 × 10⁻⁴) | | | | | | | | | |
| Glycerine (42.3/1.0 × 10⁻⁵) | | | | 10.0 | | | | | |
| 1,2-Hexanediol (14.8/2.6 × 10⁻³) | | | | | | | | | |
| Propylene Glycol (28.8/1.1 × 10⁻²) | | | | | | | | | |
| Diethylene Glycol Monobutyl Ether (11.0/1.7 × 10⁻³) | | | | | | | | | |
| Ethylene Glycol (40.4/1.2 × 10⁻²) | | | | | | | | | |
| 2-Methyl Hexane-1,3-propanediol (28.3/2.8 × 10⁻³) | | | | | | 10.0 | | | |
| 1,4-Butanediol (31.1/1.9 × 10⁻³) | | | | | | | 10.0 | | |
| 1,3-Butanediol (30.0/7.2 × 10⁻³) | | | | | | | | | |
| Trimethylolpropane (33.7/2.1 × 10⁻⁵) | | | | | 10.0 | | | | |
| Diethylene Glycol (31.7/6.3 × 10⁻⁴) | | | | | | | | 10.0 | |
| 2-Pyrrolidone (28.0/1.3 × 10⁻³) | | | | | | | | | 10.0 |
| Ethanol (23.8/1.1 × 10) | | | | | | | | | |
| BYK349 | 0.5 | 0.5 | 0.5 | 0.5 | 0.5 | 0.5 | 0.5 | 0.5 | 0.5 |
| Ion Exchanged Water | 39.5 | 39.5 | 61.1 | 44.5 | 44.5 | 44.5 | 44.5 | 44.5 | 44.5 |
| Pigment Content (P) (%) | 1.5 | 1.5 | 1.5 | 1.5 | 1.5 | 1.5 | 1.5 | 1.5 | 1.5 |
| Resin Particle Content (E) (%) | 7.5 | 7.5 | 2.1 | 7.5 | 7.5 | 7.5 | 7.5 | 7.5 | 7.5 |
| E/P Value (times) | 5.0 | 5.0 | 1.4 | 5.0 | 5.0 | 5.0 | 5.0 | 5.0 | 5.0 |
| First Solvent Content (%) | 0.0 | 0.0 | 0.0 | 10.0 | 10.0 | 0.0 | 0.0 | 0.0 | 0.0 |
| Second Solvent Content (%) | 0.0 | 0.0 | 0.0 | 10.0 | 10.0 | 10.0 | 10.0 | 10.0 | 10.0 |
| Amount of Anionic Group in Pigment Ep (μmol/g) | 398 | 398 | 398 | 398 | 398 | 398 | 398 | 398 | 398 |
| Amount of Anionic Group in Resin Particle Ee (μmol/g) | 65 | 640 | 100 | 100 | 100 | 100 | 100 | 100 | 100 |
| Ep/Ee Value (times) | 6.1 | 0.6 | 4.0 | 4.0 | 4.0 | 4.0 | 4.0 | 4.0 | 4.0 |

Components (%) indicated below were mixed and thoroughly stirred and then pressure-filtered through a cellulose acetate filter having a pore size of 3.0 μm (available from ADVANTEC CO., LTD.) to prepare an ink 50. The pigment content of the ink 50 was 5.0%, the resin particle 1 content was 6.0%, the first solvent content was 0.0% and the second solvent content was 0.0%. The amount of the anionic group in the pigment, Ep, was 398 μmol/g, the amount of the anionic group in the resin particle, Ee, was 100 μmol/g and the value of Ep/Ee was 4.0 times.
Pigment dispersion liquid 8:25.0%
Aqueous dispersion liquid of Resin particle 1:24.0%
3-Methyl-1,3-butanediol: 17.5%
1,2-Butanediol: 10.0%
BYK349: 0.5%
Ion exchanged water: 23.0%
Ink 51

With reference to the description in Japanese Patent Laid-Open No. 2020-132802, “St-Ac resin emulsion” was polymerized to produce an aqueous dispersion liquid of the resin particle 16 having a resin particle content of 25.0%. The resin forming the resin particle was a copolymer of styrene/acrylic acid/methyl methacrylate/cyclohexyl methacrylate (mass ratio 75/0.5/0.5/14.5/10), and the glass transition temperature of the resin particle 16 was 99° C.

Components (%) indicated below were mixed and thoroughly stirred and then pressure-filtered through a cellulose acetate filter having a pore size of 3.0 μm (available from ADVANTEC CO., LTD.) to prepare an ink 51. The pigment content of the ink 51 was 3.0%, the resin particle 16 content was 3.0%, the first solvent content was 0.0% and the second solvent content was 14.5%. The amount of the anionic group in the pigment, Ep, was 663 μmol/g, the amount of the anionic group in the resin particle, Ee, was 70 μmol/g, and the value of Ep/Ee was 9.5 times.
Pigment dispersion liquid 9:15.0%
Propylene glycol: 5.0%
Dipropylene glycol dimethyl ether: 3.0%
2-pyrrolidone: 13.0%
1,2-hexanediol: 2.0%
Aqueous dispersion liquid of Resin particle 16:12.0%
Wax emulsion (“AQUACER 507” (trade name), wax particle content: 35.0%, available from BYK): 8.6%
Surfactant 1 (“BYK-348” (trade name) available from BYK): 0.5%
Surfactant 2 (“OLFINE E1010” (trade name) available from Nissin Chemical Industry Co., Ltd.): 0.2%
Defoamer (“SURFYNOL DF110D” (trade name) available from Nissin Chemical Industry Co., Ltd.): 0.1%
Ion exchanged water: 40.6%
Ink 52

With reference to the description in Patent Laid-Open No. 2023-029244, a “pigment dispersion liquid” was polymerized to produce a pigment dispersion liquid 10 having a pigment (carbon black) content of 30.0% and a resin content of 6.0%. Similarly, with reference to the description in Patent Laid-Open No. 2023-029244, a “resin particle 2” was polymerized to produce a water dispersion liquid of the resin particle 17 having a resin particle content of 25.0%. The resin forming the resin particle was a urethane resin, and the glass transition temperature of the resin particle 17 was 64° C.

Components (%) indicated below were mixed and thoroughly stirred and then pressure-filtered through a cellulose acetate filter having a pore size of 3.0 μm (available from ADVANTEC CO., LTD.) to prepare an ink 52. The pigment content of the ink 52 was 6.0%, the resin particle 17 content was 8.0%, the first solvent content was 0.0% and the second solvent content was 14.5%. The amount of the anionic group in the pigment, Ep, was 634 μmol/g, the amount of the anionic group in the resin particle, Ee, was 125 μmol/g and the value of Ep/Ee was 5.1 times.
Pigment dispersion liquid 10:20.0%
Aqueous dispersion liquid of Resin particle 17:26.7%
1,2-Butanediol: 20.0%
Ion exchanged water: 33.3%

### Evaluations

Cartridges were each filled with the prepared reaction liquid and ink, and the cartridges were loaded in an ink jet recording apparatus (“imagePROGRAF PRO-2000” (trade name) available form CANON KABUSHIKI KAISHA) having a recording head that ejects ink using thermal energy. The recording apparatus includes a heating device that dries a recording medium having the applied reaction liquid and ink at a position downstream of the recording head in the transportation direction of the recording medium. The recording environment was set at a temperature of 25° C. and a relative humidity of 50%. In this example, the recording duty of 100% means that an image is recorded under the condition that 4.0 ng of a single ink droplet is applied to a unit area of 1/1,200 inch×1/1,200 inch.

The reaction liquids and inks were used as sets as indicated in Table 6 (Tables 6-1 and 6-2). Then, the reaction liquid and the ink were applied in layers at a recording duty of 15% and at a recording duty of 50%, respectively, to record a 2 cm×2 cm solid image on a recording medium. The recording medium was “Scotchcal Graphic Film IJ1220” (trade name) (available from 3M, material: polyvinyl chloride, water absorption from the start of contact to 30 msec^{1/2} according to Bristow method is within a range of 0 mL/m² or more to 10 mL/m² or less). The heating temperatures T_{F} (° C.) to dry the recording media having the applied reaction liquid and ink by the heating device are as indicated in Table 6. However, in Comparative Example 15, heating by a heating device was not performed. Thus, the T_{F} (° C.) column of Table 6 has “−”. In the examples, “AAA”, “AA”, “A” and “B” are considered as acceptable levels, and “C” is considered as an unacceptable level based on the evaluation criteria for each of the items below. In Table 6, the evaluation results are indicated in the right section.

### Suppression of Image Irregularities

The recorded images were observed with a loupe and evaluated according to the evaluation criteria below in terms of suppression of image irregularities:
A: No shading irregularities were observed on the image;
B: Fine shading irregularities of less than 2 mm were observed on the image; and
C: Shading irregularities of 2 mm or more were observed on the image.

### Water Abrasion Resistance

The recorded image was subjected to an abrasion test using a Gakushin type abrasion resistance tester in accordance with JIS L0849. Using this abrasion resistance tester, an abrasion test was performed in which a rubbing cloth (cotton) specified in JIS L0803 having 5 drops of 0.2 mL water is reciprocated 70 times on the surface of the image under a load of 500 g. The number of reciprocations when image chipping occurred during the abrasion test was checked, and the water abrasion resistance of the image was evaluated based on the evaluation criteria below:
AAA: No image chipping was observed after 40 reciprocations;
AA: The image was damaged after 30 or more reciprocations to 40 or less reciprocations;
A: The image was damaged after 20 or more reciprocations to less than 30 reciprocations;
B: The image was damaged after 10 or more reciprocations to less than 20 reciprocations; and
C: The image was damaged after less than 10 reciprocations.

TABLE 6-1
Evaluation Condition and Evaluation Results

| | | Evaluation Condition | | | | | Evaluation Result | |
|---|---|---|---|---|---|---|---|---|
| | | | | Heating | Resin | | Image | Water |
| | | Reaction | | Temperature | Particle | T_{F} − T_{G} | Irregularity | Abrasion |
| | | Liquid | Ink | T_{F} (° C.) | T_{G} (° C.) | (° C.) | Suppression | Resistance |
| Examples | 1 | 1 | 1 | 80 | 60 | 20 | A | AAA |
| | 2 | 2 | 1 | 80 | 60 | 20 | A | AAA |
| | 3 | 3 | 1 | 80 | 60 | 20 | A | AAA |
| | 4 | 4 | 1 | 80 | 60 | 20 | A | AAA |
| | 5 | 5 | 1 | 80 | 60 | 20 | A | AAA |
| | 6 | 1 | 2 | 80 | 60 | 20 | A | AAA |
| | 7 | 1 | 3 | 80 | 60 | 20 | A | AAA |
| | 8 | 1 | 4 | 80 | 60 | 20 | A | AAA |
| | 9 | 1 | 5 | 80 | 60 | 20 | A | AAA |
| | 10 | 1 | 6 | 80 | 60 | 20 | A | AAA |
| | 11 | 1 | 7 | 80 | 60 | 20 | A | AAA |
| | 12 | 1 | 8 | 80 | 60 | 20 | A | AAA |
| | 13 | 1 | 9 | 80 | 60 | 20 | A | AAA |
| | 14 | 1 | 10 | 80 | 60 | 20 | B | AAA |
| | 15 | 1 | 11 | 80 | 60 | 20 | A | AA |
| | 16 | 1 | 12 | 80 | 60 | 20 | A | AAA |
| | 17 | 1 | 13 | 80 | 60 | 20 | A | AAA |
| | 18 | 1 | 14 | 80 | 60 | 20 | A | AA |
| | 19 | 1 | 15 | 80 | 60 | 20 | A | AA |
| | 20 | 1 | 16 | 80 | 60 | 20 | A | AA |
| | 21 | 1 | 17 | 80 | 60 | 20 | A | AA |
| | 22 | 1 | 18 | 80 | 60 | 20 | A | AA |
| | 23 | 1 | 19 | 80 | 60 | 20 | A | AA |
| | 24 | 1 | 20 | 80 | 60 | 20 | A | AA |
| | 25 | 1 | 1 | 50 | 60 | −10 | A | AAA |
| | 26 | 1 | 21 | 80 | 60 | 20 | B | AAA |
| | 27 | 1 | 22 | 80 | 60 | 20 | A | AAA |
| | 28 | 1 | 23 | 80 | 60 | 20 | A | AAA |
| | 29 | 1 | 24 | 80 | 60 | 20 | A | AA |
| | 30 | 1 | 25 | 80 | 60 | 20 | A | AAA |
| | 31 | 1 | 26 | 80 | 60 | 20 | A | AA |
| | 32 | 1 | 27 | 80 | 60 | 20 | A | AAA |
| | 33 | 1 | 28 | 80 | 60 | 20 | A | AA |
| | 34 | 6 | 1 | 80 | 60 | 20 | A | AA |
| | 35 | 7 | 1 | 80 | 60 | 20 | A | AAA |
| | 36 | 8 | 1 | 80 | 60 | 20 | A | AA |
| | 37 | 9 | 1 | 80 | 60 | 20 | B | AA |
| | 38 | 10 | 29 | 80 | 60 | 20 | A | AA |
| | 39 | 10 | 1 | 80 | 60 | 20 | A | AA |
| | 40 | 1 | 30 | 80 | 25 | 55 | A | AA |
| | 41 | 1 | 31 | 80 | 30 | 50 | A | AAA |

TABLE 6-2
Evaluation Condition and Evaluation Result

| | | Evaluation Condition | | | | | Evaluation Result | |
|---|---|---|---|---|---|---|---|---|
| | | | | Heating | Resin | | Image | Water |
| | | Reaction | | Temperature | Particle | T_{F} − T_{G} | Irregularity | Abrasion |
| | | Liquid | Ink | T_{F} (° C.) | T_{G} (° C.) | (° C.) | Suppression | Resistance |
| Examples | 42 | 1 | 32 | 80 | 80 | 0 | A | AAA |
| | 43 | 1 | 33 | 80 | 60 | 20 | A | B |
| | 44 | 1 | 34 | 80 | 60 | 20 | A | B |
| | 45 | 1 | 35 | 80 | 60 | 20 | A | A |
| | 46 | 1 | 36 | 80 | 60 | 20 | A | A |
| | 47 | 1 | 37 | 80 | 60 | 20 | A | AAA |
| | 48 | 11 | 1 | 80 | 60 | 20 | B | AAA |
| | 49 | 12 | 1 | 80 | 60 | 20 | A | AAA |
| | 50 | 13 | 1 | 80 | 60 | 20 | A | AAA |
| | 51 | 14 | 1 | 80 | 60 | 20 | A | AA |
| | 52 | 15 | 1 | 80 | 60 | 20 | B | AAA |
| | 53 | 16 | 1 | 80 | 60 | 20 | A | AAA |
| | 54 | 17 | 1 | 80 | 60 | 20 | A | AAA |
| | 55 | 18 | 1 | 80 | 60 | 20 | A | AA |
| | 56 | 19 | 1 | 80 | 60 | 20 | B | AAA |
| | 57 | 20 | 1 | 80 | 60 | 20 | A | AAA |
| | 58 | 21 | 1 | 80 | 60 | 20 | A | AAA |
| | 59 | 22 | 1 | 80 | 60 | 20 | A | AA |
| | 60 | 23 | 1 | 80 | 60 | 20 | B | AAA |
| | 61 | 24 | 1 | 80 | 60 | 20 | A | AAA |
| | 62 | 25 | 1 | 80 | 60 | 20 | A | AAA |
| | 63 | 26 | 1 | 80 | 60 | 20 | A | AA |
| | 64 | 27 | 38 | 80 | 25 | 55 | B | B |
| Comparative | 1 | 28 | 1 | 80 | 60 | 20 | C | C |
| Examples | 2 | 29 | 1 | 80 | 60 | 20 | A | C |
| | 3 | 30 | 1 | 80 | 60 | 20 | A | C |
| | 4 | 1 | 39 | 80 | — | — | C | AAA |
| | 5 | 1 | 40 | 80 | 60 | 20 | C | AAA |
| | 6 | 1 | 41 | 80 | 60 | 20 | C | AAA |
| | 7 | 1 | 42 | 80 | 60 | 20 | A | C |
| | 8 | 1 | 43 | 80 | 60 | 20 | A | C |
| | 9 | 1 | 44 | 80 | 60 | 20 | A | C |
| | 10 | 1 | 45 | 80 | 60 | 20 | A | C |
| | 11 | 1 | 46 | 80 | 60 | 20 | A | C |
| | 12 | 1 | 47 | 80 | 60 | 20 | A | C |
| | 13 | 1 | 48 | 80 | 60 | 20 | A | C |
| | 14 | 1 | 49 | 80 | 60 | 20 | A | C |
| | 15 | 1 | 1 | — | 60 | — | A | C |
| | 16 | 1 | 1 | 45 | 60 | −15 | A | C |
| | 17 | 31 | 50 | 100 | 60 | 40 | A | C |
| | 18 | 32 | 51 | 70 | 99 | −29 | C | C |
| | 19 | 33 | 52 | 80 | 64 | 16 | A | C |

The image irregularity evaluation results for Examples 48, 52, 56 and 60 were all ranked “B,” but Example 48 was relatively inferior.

The present disclosure can provide an ink jet recording method that advantageously suppresses image irregularities and can record images having excellent water abrasion resistance. Furthermore, the present disclosure can provide an ink jet recording apparatus for this ink jet recording method.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2024-009740, filed on Jan. 25, 2024, and 2024-221044, filed on Dec. 17, 2024, which are hereby incorporated by reference herein in their entirety.

What is claimed is:

1. An ink jet recording method of recording an image on a recording medium by using an aqueous ink and an aqueous reaction liquid containing a reactant that reacts with the aqueous ink, the method comprising:
a reaction liquid applying step of applying the aqueous reaction liquid to the recording medium;
an ink applying step of applying the aqueous ink to the recording medium over at least a portion of an area to which the aqueous reaction liquid is applied; and
a heating step of heating the recording medium having the applied aqueous ink and aqueous reaction liquid to a predetermined heating temperature T_{F} (° C.), wherein
the recording medium has a water absorption amount from a start of contact to 30 msec^{1/2} according to Bristow method of 10 mL/m² or less,
the reactant comprises at least one acidic compound selected from the group consisting of an organic acid and an inorganic acid,
the aqueous ink comprises a pigment and a resin particle dispersed by action of an anionic group,
the resin particle has an anionic group in an amount of 75 μmol/g or more to 600 μmol/g or less,
a content (% by mass) of the resin particle is 1.5 times or more a content (% by mass) of the pigment on a mass basis,
a content of a first water-soluble organic solvent having a vapor pressure of 3.1×10⁻⁵ kPa or less in the aqueous ink is 9.0% by mass or less based on the total mass of the aqueous ink and a content of a second water-soluble organic solvent having a relative permittivity of 28.0 or more and a vapor pressure of 4.0×10⁻³ kPa or less in the aqueous ink is 9.0% by mass or less based on the total mass of the aqueous ink, and
the heating temperature T_{F} (° C.) of the recording medium and a glass transition temperature T_{G} (° C.) of the resin particle satisfy formula (1):
$${T}_{F} \geq ( {T}_{G} - 10 ) . \qquad ( 1 )$$

2. The ink jet recording method according to claim 1, wherein the resin particle has the anionic group in an amount of 95 μmol/g or more to 270 μmol/g or less.

3. The ink jet recording method according to claim 1, wherein a content of the first water-soluble organic solvent in the aqueous ink is 3.0% by mass or less based on the total mass of the aqueous ink, and
a content of the second water-soluble organic solvent in the aqueous ink is 3.0% by mass or less based on the total mass of the aqueous ink.

4. The ink jet recording method according to claim 1, wherein the acidic compound in the aqueous reaction liquid comprises the organic acid.

5. The ink jet recording method according to claim 4, wherein the organic acid has a pKa of 4.9 or less.

6. The ink jet recording method according to claim 4, wherein the pKa of the organic acid is less than or equal to a pKa of the anionic group of the resin particle.

7. The ink jet recording method according to claim 1, wherein the glass transition temperature T_{G} (C) of the resin particle is 30° C. or more.

8. The ink jet recording method according to claim 1, wherein the aqueous ink further comprises a third water-soluble organic solvent having a lower vapor pressure than water.

9. The ink jet recording method according to claim 8, wherein the third water-soluble organic solvent comprises a 1,2-alkanediol.

10. The ink jet recording method according to claim 9, wherein, in the aqueous ink, an amount (μmol/g) of the anionic group in the pigment is 2.0 times or more an amount (μmol/g) of the anionic group in the resin particle.

11. The ink jet recording method according to claim 1, wherein the aqueous reaction liquid further comprises a polyvalent metal salt, and
the polyvalent metal salt has a solubility of 70.0 g/100 mL or less in 20° C. water.

12. The ink jet recording method according to claim 11, wherein, in the aqueous reaction liquid, a content of the polyvalent metal salt is 0.60 times or more to 10.0 times or less a content of the acidic compound on a molar basis.

13. The ink jet recording method according to claim 1, wherein the aqueous reaction liquid further comprises a cationic resin, and
the cationic resin has a cationicity of 3 meq/g or more to 7 meq/g or less.

14. The ink jet recording method according to claim 13, wherein, in the aqueous reaction liquid, a content (% by mass) of the cationic resin is 1.25 times or more to 12.60 times or less a content (% by mass) of the acidic compound on a molar basis.

15. An ink jet recording apparatus configured to record an image on a recording medium by using an aqueous ink and an aqueous reaction liquid containing a reactant that reacts with the aqueous ink, the apparatus comprising:
a reaction liquid applicator configured to apply the aqueous reaction liquid to the recording medium;
an ink applicator configured to apply the aqueous ink to the recording medium over at least a portion of an area to which the aqueous reaction liquid is applied; and
a heater configured to heat the recording medium having the applied aqueous ink and aqueous reaction liquid to a predetermined heating temperature T_{F} (° C.), wherein
the recording medium has a water absorption amount from a start of contact to 30 msec^{1/2} according to Bristow method of 10 mL/m² or less,
the reactant comprises at least one acidic compound selected from the group consisting of an organic acid and an inorganic acid,
the aqueous ink comprises a pigment and a resin particle dispersed by action of an anionic group,
the resin particle comprises an anionic group in an amount of 75 μmol/g or more to 600 μmol/g or less,
a content (% by mass) of the resin particle is 1.5 times or more than a content (% by mass) of the pigment on a mass basis,
a content of a first water-soluble organic solvent having a vapor pressure of 3.1×10⁻⁵ kPa or less in the aqueous ink is 9.0% by mass or less based on the total mass of the aqueous ink and a content of a second water-soluble organic solvent having a relative permittivity of 28.0 or more and a vapor pressure of 4.0×10⁻³ kPa or less in the aqueous ink is 9.0% by mass or less based on the total mass of the aqueous ink, and
the heating temperature T_{F} (° C.) of the recording medium and a glass transition temperature T_{G} (° C.) of the resin particle satisfy formula (1):
$${T}_{F} \geq ( {T}_{G} - 10 ) . \qquad ( 1 )$$
